(19) United States
(12) Patent Application Publication
(10) Pub. No.: US 2013/0287673 A1
(43) Pub. Date: Oct. 31, 2013

(54) CAPTURE OF CARBON DIOXIDE

(71) Applicants: Xialong WANG, Nottingham (GB); Mercedes Maroto-Valer, Nottingham (GB)

(72) Inventors: Xialong WANG, Nottingham (GB); Mercedes Maroto-Valer, Nottingham (GB)

(21) Appl. No.: 13/847,381

(22) Filed: Mar. 19, 2013

Related U.S. Application Data
(63) Continuation of application No. 13/518,199, now abandoned.

(30) Foreign Application Priority Data
Dec. 22, 2009 (GB) 0922386.8

(51) Int. Cl. C01B 31/20

(52) U.S. Cl. CPC C01B 31/20
USPC 423/431; 422/168

(57) ABSTRACT

A method for capturing carbon dioxide comprising the steps of extracting mineral ions from a mineral source material to a mineral solution by reaction with a first ammonium salt; reacting the mineral solution with a CO₂ source to precipitate a carbonate of the mineral and to produce a second ammonium salt; and recovering the first ammonium salt from the second ammonium salt.

### FIELD OF THE INVENTION

The present invention relates to the capture of carbon dioxide.

### BACKGROUND TO THE INVENTION

The Inconvenient truth of climate change has forced us to reduce CO₂ emissions urgently. CO₂ geological storage is thought to be one of the most important strategies for carbon mitigation and to progress from demonstration scale to large industrial scale technologies. However, geological storage is a very location-dependent technology. Many countries cannot find appropriate geological formations, such as Finland [1]. Or, the distances from storage site to the CO₂ producer site can be thousands of kilometres, which causes high pipeline construction cost. For example, in China, the optimum storage site in the eastern sea area is far from its majority of power plants in the Huabei area.

CO₂ mineralization is another potential option for long-term storage of CO₂. Mineral sequestration is a promising strategy to permanently and safely to store anthropogenic generated carbon dioxide (CO₂) in solid Mg- and Ca-carbonates. Advantages of mineral carbonation include vast storage capacity, permanent storage, less leakage risk, and the fact that mineralization is an exothermal reaction. However, mineral sequestration also faces many problems such as low efficiency, slow kinetics, and energy intensive pre-treatment processes [2]. Although, some barriers like low efficiency and slow kinetics have been solved by using pH-swing process, the need to add large amounts of acid and base limit the development of mineral sequestration.

We have realised that it is feasible to create a new pH-swing process by using recyclable ammonium salts instead of traditional acids and bases. The dissolution of serpentine by using recyclable ammonium salts is one embodiment that we have worked on.

### Serpentine

Calcium and magnesium are generally selected as feedstock for CO₂ mineralization. For reactivity, carbonation of calcium is easier, but the magnesium minerals, mostly serpentine, are abundantly available worldwide. Mineral carbonation have vast storage capacity, for instance, a deposit in Oman of 30,000 km³ magnesium silicates which alone would be able to store most of the CO₂ generated by combustion of the world's coal reserves [3].

Current pH-Swing CO₂ Mineralization Process

Previous studies indicated that mineral dissolution is the rate-limiting step in direct aqueous mineral carbonation systems [4], since the acidity produced by pressurised CO₂ in aqueous solution was not efficient. Subsequently, the carbonation of the leaching solution was promoted by using a basic medium. This indirect process is generally called a pH-swing process. Park et al. [5]proposed a pH-swing process using mixed weak acid solvents with 1 vol % orthophosphoric acid, 0.9 wt % of oxalic acid and 0.1 wt % EDTA to promote mineral leaching, and nesquehonite (MgCOs₃.3H₂O) was obtained from carbonation of Mg leaching solution by raising the pH of the solution to 9.5 with NH₄OH.

In the study of Teir et al. [6], serpentine was dissolved in HCl or HNO₃, and then hydromagnesite (4MgCO₃.Mg(OH)₂.4H₂O) was obtained by controlling the Mg leaching solution pH to 9 with addition of NaOH. For these processes, large amounts of acid and base are required for the mineral dissolution and carbonate reactions.

The cost of the constituent chemicals in these processes alone (600-1600 US$/t CO₂) is much more than the budget for CO₂ emission allowances (30 [symbol] /t CO₂). Thus, recycling of all chemicals involved is important for economic reasons.

There is a need to find low cost recyclable solvents that can provide high efficiency of mineral dissolution and carbonation. Recently, Krevor et al. [27] tested NH₄Cl, NaCl, sodium citrate, sodium EDTA, sodium oxalate, and sodium acetate to dissolve serpentine. All experiments were carried out at 120° C. and 20 bars of CO₂ in a batch autoclave. For 0.1 M citrate, EDTA and oxalate solutions, 60% dissolution efficiency of Mg from serpentine was achieved within 2 hours, going up to 80% after 7 hours and reaching nearly 100% between 10 and 20 hours. Therefore, the mineral dissolution with organic solvents is promising in terms of dissolution efficiency but the reaction rate is relatively slow. Pundsack et al. [28] reported the use of NH₄HSO₄ in serpentine dissolution and bubbled CO₂ directly into the obtained high concentration Mg solution with ammonia water for carbonation. The dissolution efficiency of Mg was 92.8%, but the carbonation efficiency was only 35%. Fagerlund et al. [29]proposed a process of production of Mg(OH)₂ from serpentine using (NH₄)₂SO₄. Solid-solid reaction of serpentine with (NH₄)₂SO₄ was carried out at 440° C. to generate MgSO₄, that was put into ammonia water to precipitate Mg(OH)₂ and regenerate (NH₄)₂SO₄, Mg(OH)₂ was then carbonated with CO₂ directly at a pressurized fluidized bed (PFB) reactor at 470-550° C. and 20 bar. But only 20-50% extraction efficiency of Mg from serpentine was reported [30], and the carbonation efficiency of Mg(OH)₂ achieved maximum 50% since the exist of MgO, which can not be carbonated at the above reaction temperature [31]. More work is needed to improve both dissolution and carbonation efficiencies.

Consequently there is an ongoing need for improved methods and apparatuses for capturing carbon dioxide.

### SUMMARY OF THE INVENTION

Accordingly, in a first aspect, the present invention provides a method for capturing carbon dioxide comprising the steps of:
extracting mineral ions from a mineral source material to a mineral solution by reaction with a first ammonium salt;
reacting the mineral solution with a CO₂ source to precipitate a carbonate of the mineral and to produce a second ammonium salt;
and recovering the first ammonium salt from the second ammonium salt.

In a further aspect the invention provides an apparatus for capturing carbon dioxide comprising

means for extracting mineral ions from a mineral source material to a mineral solution by reaction with a first ammonium salt;
means for reacting the mineral solution with a CO₂ source to precipitate a carbonate of the mineral and to produce a second ammonium salt;
and means for recovering the first ammonium salt from the second ammonium salt.

In embodiments, the mineral ions may be magnesium or calcium ions. The mineral ions may be derived from a magnesium silicate or a calcium silicate, preferably serpentine or olivine. Preferably the mineral source material is serpentine or olivine or another suitable magnesium or calcium silicate. Preferably, the mineral source is in a substantially pure form although it may equally contain impurities. In certain embodiments the mineral source material is a mineral waste material. In preferred embodiments the mineral source is used in its naturally occurring form. Preferably, the mineral ions may be extracted by reaction with ammonium bisulphate. The mineral solution may be regulated to neutral pH before reacting with the CO₂ source. Preferably the pH is regulated using ammonia.

The CO₂ source may be an intermediate product, preferably an intermediate product obtained by capturing CO₂ from a waste stream. The CO₂ may be captured by reaction with ammonia. The intermediate product may be ammonium bicarbonate. The recovery step may include the production of ammonia. The recovered ammonia may be used for capturing CO₂.

The first ammonium salt may be recovered by a process which includes evaporation and/or heating; preferably heating to a temperature of from 250° C. to 350° C., more preferably to a temperature of between 300° C. and 350° C., even more preferably to a temperature between 320° C. and 335° C., more preferably to a temperature at or below 330° C., preferably the first ammonium salt should not decompose as a result of said heating. The recovered first ammonium salts may be used for further extraction of mineral ions from the mineral source material.

In a further aspect, the invention provides a method comprising: capturing CO₂ by reacting CO₂ with ammonia to produce an intermediate product; and using the intermediate product as a CO₂ source in a mineral carbonation process.

In a still further aspect, the invention provides an apparatus for capturing carbon dioxide comprising means for reacting CO₂ with ammonia to produce an intermediate product and using the intermediate product as a CO₂ source in a mineral carbonation process.

In embodiments, the CO₂ is from a waste stream, preferably a gas waste stream, preferably a gas waste stream from the burning of fuel. Waste stream is understood to mean a source of CO₂ wherein the CO₂ is a by-product of another process, preferably a by-product of burning fuel.

The intermediate product may be ammonium bicarbonate. Preferably the ammonium bicarbonate is placed into solution at a temperature above 50° C., preferably above 60° C., preferably at a temperature from 60° C. to 90° C. The mineral carbonation process may include reacting the intermediate product with a mineral solution. Preferably the reaction between the intermediate product and the mineral solution is carried out in the presence of ammonia. The mineral solution may be obtained by extracting mineral ions from a mineral source material to a mineral solution by reaction with an ammonium salt. The mineral ions may be magnesium. The mineral ions may be derived from serpentine. The mineral ions may be extracted by reaction with ammonium bisulphate.

In a preferred embodiment the intermediate product is NH₄HCO₃ and the mineral ions are magnesium ions and they are reacted in the presence of ammonia in a mass ratio of Mg:NH₄HCO₃:NH₃ of from 1:3:1 to 1:5:3, preferably 1:3:1 to 1:4:2, most preferably 1:4:2.

In a still further aspect, the invention provides a process for producing power comprising the steps of producing CO₂ by burning a fuel and capturing the CO₂ using a method or apparatus as described above.

### BRIEF DESCRIPTION OF THE FIGURES

The above mentioned and other features of this invention, and the manner of attaining them, will become more apparent and the invention itself will be better understood by reference to the following description of embodiments of the invention taken in conjunction with the accompanying tables and figures wherein:

Table 1: Chemical reactions and thermodynamic data in different steps of process

Table 2: Elemental analysis of serpentine sample

Table 3: Elemental composition of solution sampling at 3 hours and filtrate solution (110° C., 75-150 μm, 1.4 M NH4HSO4)

Table 4: Multiple regression coefficients for experimental kinetic data fitted to constant size particles models

Table 5: Data on dissolution of serpentine from literature

Table 6: Matrix of the molar ratios Mg:NH₄HCO₃:NH₃ and carbonation efficiency in carbonation experiments

Table 7: Summary ICP-AES analyses of liquid produced in the experiment (units: mg/l)

Table 8: Summary from XRF analyses of solids used and produced in the experiment (units: wt %), the CO₂ contain from TGA analysis.

FIG. 1: Schematic process route of pH-swing CO₂ mineral sequestration with recyclable ammonium salts

FIG. 2: Experimental setup for dissolution experiments

FIG. 3: Schematic constant size particles dissolution model

FIG. 4: XRD pattern of serpentine sample

FIG. 5: TGA graph of serpentine sample

FIG. 6: Selection of ammonium salts for serpentine dissolution (20 grams serpentine in 400 ml 2M solvent solution at 70° C. for 3 hours)

FIG. 7: Mg extraction from serpentine (20 grams) In 1.4 M NH4HSO4 solution (400 ml) at 70, 90 and 110° C. for 3 hours (tested by ICP-AES)

FIG. 8: Fe extraction from serpentine (20 grams) in 1.4 M NH4HSO4 solution (400 ml) at 70, 90 and 110° C. for 3 hours (tested by ICP-AES)

FIG. 9: Si extraction from serpentine (20 grams) in 1.4 M NH4HSO4 solution (400 ml) at 70, 90 and 110° C. for 3 hours (tested by ICP-AES)

FIG. 10: 1-3(1-XMg)2/3+2(1-XMg) vs. reaction temperature for extraction of Mg from serpentine in 1.4 M NH4HSO4

FIG. 11: Arrhenius plot for extraction of Mg from serpentine in 1.4 M NH4HSO4 including trend line equation

FIG. 12: Modified process route of pH-swing CO₂ mineral sequestration with recyclable ammonium salts

FIG. 13: Comparison of the process steps and net power generation percentages between carbon capture and geological storage and integrated carbon capture and mineral carbonation

FIG. 14: Dissolution efficiency of different elements after serpentine dissolution by NH₄HSO₄ (Experiment 3, 100° C., 2 h)

FIG. 15: XRD pattern of product 2 of experiment 7.

FIG. 16: Temperature, time, pH and concentration of Mg in solution during the course of a typical carbonation experiment (Experiment 7)

FIG. 17: XRD pattern of product 3 of experiment 7

FIG. 18: TGA profiles of product 3 and product 4 from experiment 7, NH₄HSO₄ and (NH₄)₂SO₄

FIG. 19: Temperature, time, pH and concentration of Mg in solution during the course of a carbonation experiment when double ammonium carbonate precipitate (Experiment 4)

FIG. 20: Plotted data of carbonation efficiency vs. molar ratio of Mg—NH₄HCO₃—NH₃

### DETAILED DESCRIPTION OF THE INVENTION

Examples will be described of a new pH-swing CO₂ mineral sequestration process using recyclable ammonium salts. In this process, magnesium ions were extracted from serpentine in ammonium salts solution. The Mg-rich leaching solution reacts with intermediate product (in some embodiments ammonium bicarbonate) of a CO₂ capture step to precipitate hydromagnesite at mild heating conditions, preferably greater than 70° C., preferably at about 70° C. The application of intermediate product instead of CO₂ could remove the need to perform CO₂ compression, which consumes extensive energy. In addition, at the end of carbonation, preferably greater than 70%, more preferably greater than 80%, and most preferably all ammonium salts and ammonia used could be regenerated by thermal decomposition. The feasibility of the proposed process was confirmed by successful experimental work. In a study, the dissolution of serpentine performed by a series of solvents showed that NH₄HSO₄ was most efficient at magnesium extraction. At 110° C. 1.4 M NH₄HSO₄ was able to extract 100% of magnesium from serpentine in 3 hours, simultaneously 98% of iron and 17.6% of silicon. The rate limiting mechanism of serpentine dissolution with NH₄HSO₄ is a chemical reaction with product layer diffusion control and the apparent activation energies of this dissolution was 40.9 kJ mol⁻¹.

### Alternative Process by Using Recyclable Additives

The new pH-swing mineral sequestration process using recyclable ammonium salts is described as follows. The process preferably consists of five main steps, where reactions occur, listed in Table 1. Firstly, ammonia will be used to capture CO₂ from a power plant's flue gas and produce ammonium bicarbonate (NH₄HCO₃) in the capture step. Thus, CO₂ is captured from a waste stream by reaction with ammonia to produce an intermediate product. Secondly, the ammonium bisulphate (NH₄HSO₄) is used to extract magnesium (Mg) ions from serpentine at mild heating conditions in the mineral dissolution step. Thus, mineral ions are extracted from a mineral source material to a mineral solution by reaction with an ammonium salt. Thirdly, the Mg-rich solution produced from mineral dissolution is regulated to neutral pH by adding ammonia water; then, the impurities in the leaching solution are removed by adding ammonia water. After that, the solution is reacted with the intermediate product (ammonium bicarbonate (NH₄HCO₃)) from the CO₂ capture step to precipitate carbonates at mild temperature. Thus, the mineral solution is reacted with a CO₂ source to precipitate a carbonate of the mineral and to produce a second ammonium salt. Thus, the intermediate product is used as a CO₂ source in a mineral carbonation process. Since the formation of the carbonate produced is affected by the temperature, the nesquehonite (MgCO₃.3H₂O) will transfer to hydromagnesite (4MgCO₃*Mg(OH)₂*4H₂O) above 70° C. With the precipitation of hydromagnesite, the final solution mainly contains ammonium sulphate. Finally, the ammonium sulphate could be collected (e.g. by evaporation) and subsequently heated up to regenerate ammonia which goes back to the capture step and ammonium bisulphate which is reused in mineral dissolution. Thus, the first ammonium salt is recovered from the second ammonium salt.

In the thermal decomposition of Mg(HCO₃)₂ into MgCO₃, a maximum 50% bicarbonate ion can convert into carbonate. The other 50% bicarbonate will change to gas CO₂, which is a big waste. The joint use of ammonia water and ammonium bicarbonate will improve the CO₂ utilization rate. The mechanism could be explained by the following reaction equations:
A. When ammonia water is pre-added in system:

MgSO₄+2NH₄OH→Mg(OH)₂+(NH₄)₂SO₄ (Eq. 1)
B. When ammonium bicarbonate is added after addition of ammonia water:

MgSO₄+NH₃+NH₄HCO₃→MgCO₃↓+(NH₄)₂SO₄ (Eq. 1)

MgSO₄+NH₄HCO₃→Mg(HCO₃)₂+(NH₄)₂SO₄ (Eq. 2)

Mg(HCO₃)₂→MgCO₃↓+H₂O+CO₂↑ (Eq. 3)
C. The release CO₂ gas react with Magnesium hydroxide:

Mg(OH)₂+2CO₂→Mg(HCO₃)₂ (Eq. 4)
D. Magnesium hydroxide may react with magnesium bicarbonate:

Mg(OH)₂+Mg(HCO₃)₂→+2MgCO₃↓+2H₂O (Eq. 5)

So, the utilization of CO₂ will improve by pre-addition of ammonia water.

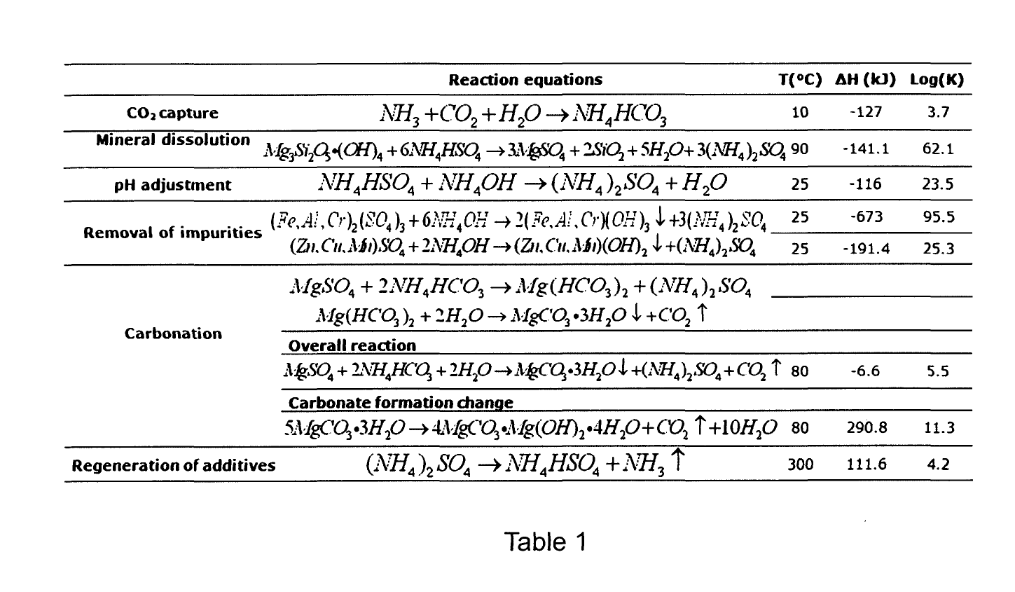

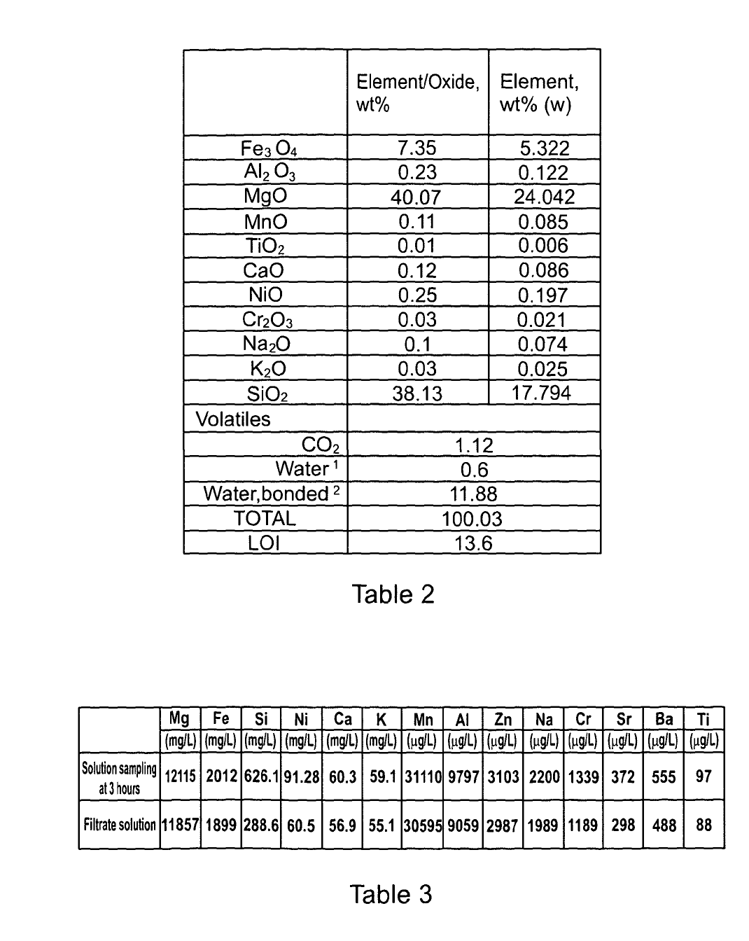

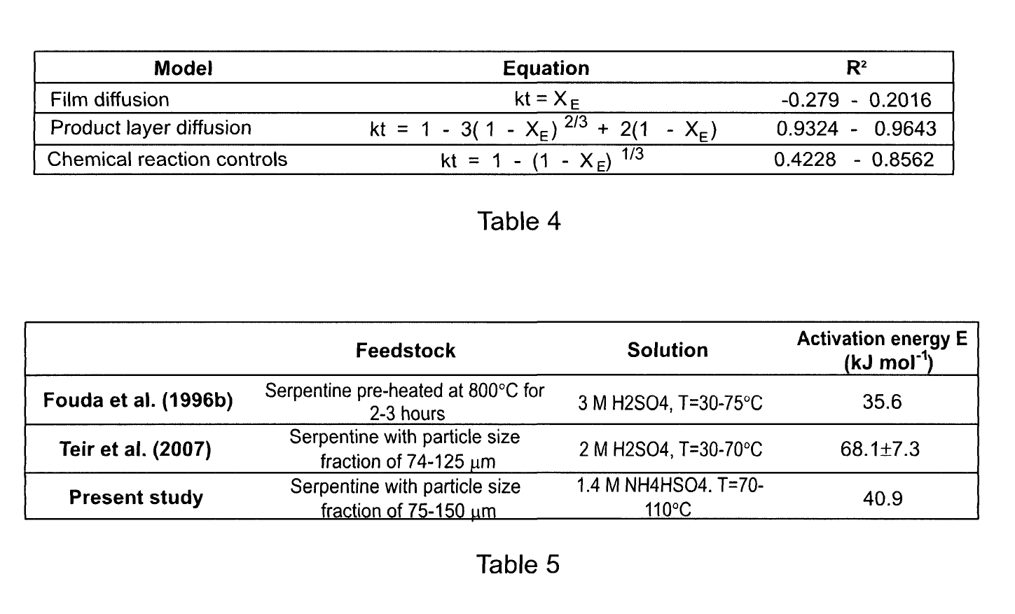

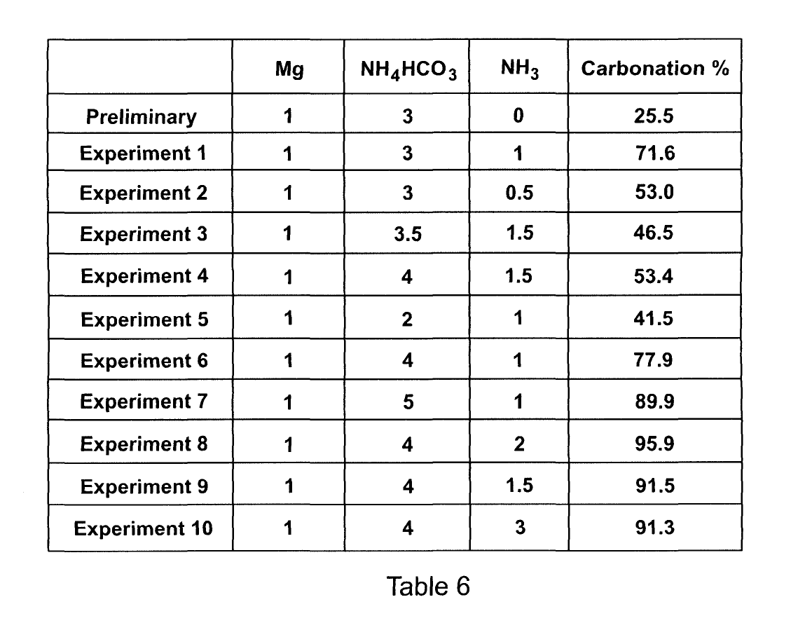

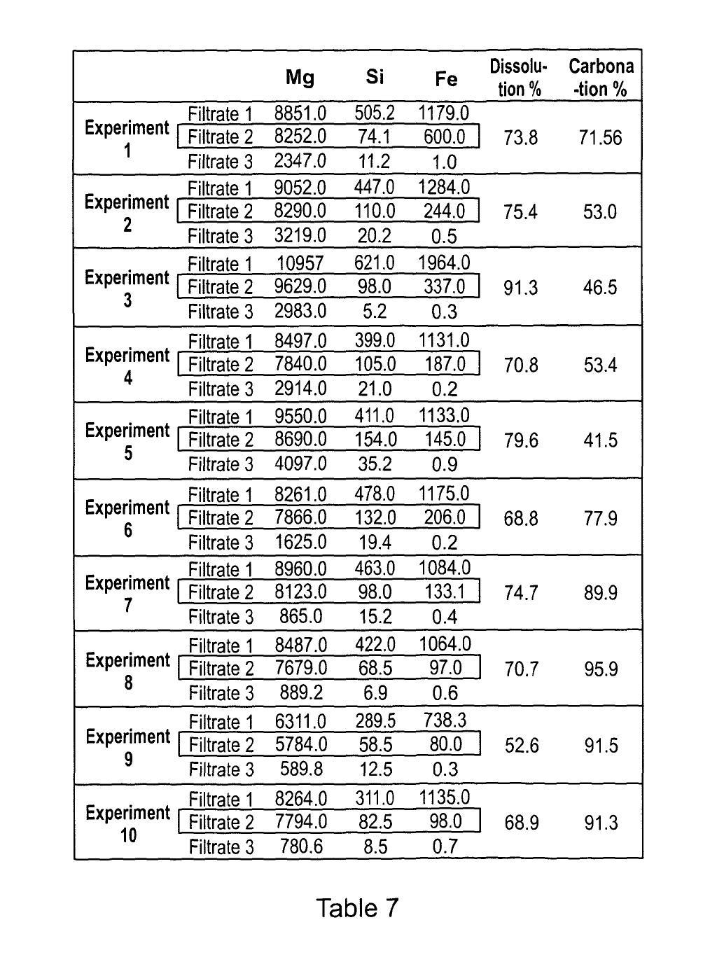

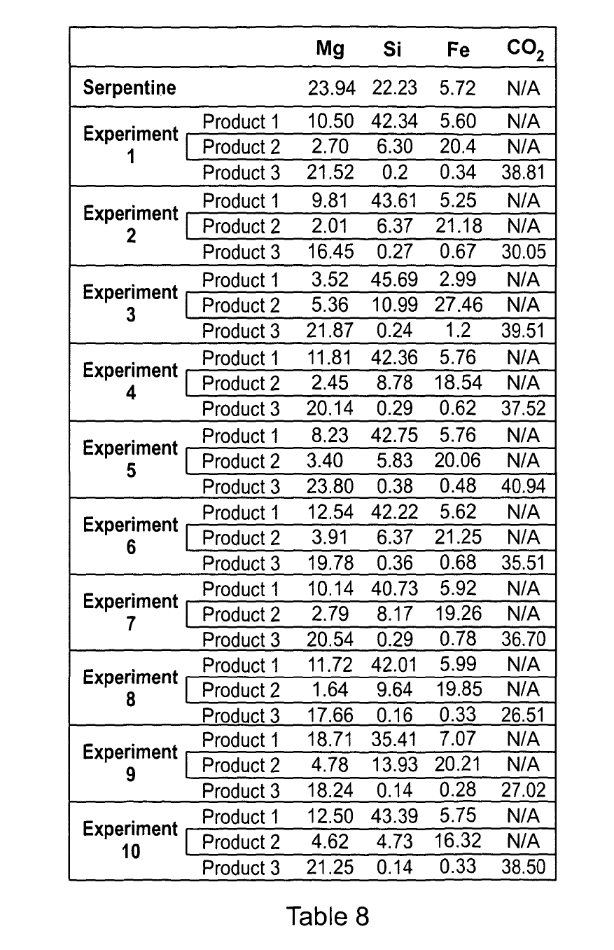

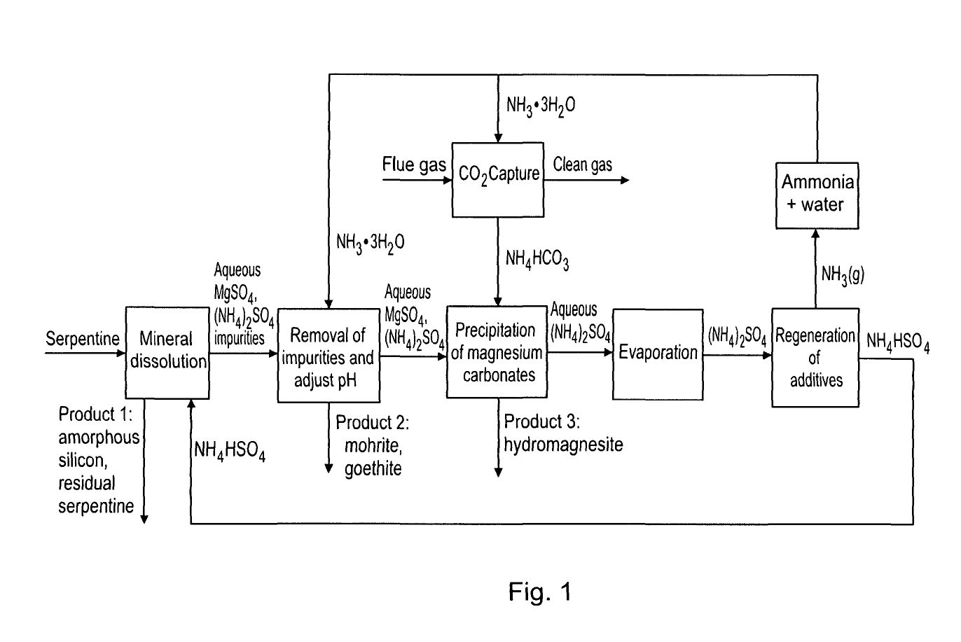

The process routes are indicated in FIG. 1. It can be seen that there are 3 products from this process. The first product from the mineral dissolution mainly contains amorphous silica (quartz) and minor residual serpentine. If the dissolution step is conducted at high temperature (above 100° C.), the reaction will proceed completely so that high purity amorphous silica can be obtained from dissolution. Normally the amorphous silica produced from serpentine dissolution had a purity of 82-88% by weight, but it can be refined into 99% by weight pure silica using ultrasonic and electromagnetic separation as well as calcination. Pure silica is widely used in electronic, automotive, chemical, and ceramic industries [6]. Thus the silica by-product can be used in other industries.

The second product results from the removal of impurities and is rich in Fe, such as mohrite ((NH₄)₂Fe(SO₄)₂) and goethite (FeO(OH)). This Fe-rich product could possibly be suitable for the iron industry and the manufacture of pigments. The third product results from the carbonation step and is hydromagnesite with a very high purity (for example over 90% or over 95% or over 99%). Therefore, this product could be sold as a valuable product. The application of hydromagnesite is quite wide in the paper industry, cement industry, civil engineering and production of fire retardant [7].

### Process Comparison

In the prior art, the CO₂ capture and mineral sequestration are considered as two separate processes. In the capture process, the CO₂ is first absorbed or adsorbed by different kinds of chemicals, such as MEA, amine and ammonia [8]. The CO₂ is then desorbed by heating or some other methods to recover the sorbents and release CO₂. The CO₂ is then compressed in order to be transferred to the storage site. However, compression consumes a lot of energy, which nearly accounts for 25% of the total energy consumption of the whole CCS process [9].

However, we have realised that the intermediate product in the capture step, for example NH₄HCO₃ in the ammonia method, has the potential to be used in mineral carbonation directly. In this case there is no need for desorption and compression of CO₂ any more, and thus the cost of the whole CCS process would be significant reduced. The new pH-swing mineral carbonation process is proposed to combine capture and storage together to save CO₂ compression and transportation steps.

### Further Details of Our Method—Example Test

### Characterization of Serpentine Sample

A serpentine sample from Cedar Hills quarry in southeast Pennsylvania and supplied by Albany Research Center (U.S.), was selected for experimental study. A batch of 10 kg serpentine rocks was ground and sieved, from which a particle size fraction of 75-150 μm was selected for the experiments. Samples of the sieved 75-150 μm fraction was analyzed using X-Ray Diffraction (XRD). For measurement of the contents of elements in the serpentine, samples of the sieved fraction were completely dissolved using HF solutions in microwave digestion. The solutions were analyzed with Inductively Coupled Plasma-Atomic Emission Spectrometry (ICP-AES) using two different wave lengths to give a more exact reference number for the concentrations of Mg, Si, Fe, Ca, Al, Ni, Mn, Cr, Cu, Al, Sr, Na, Ti and Ba in serpentine. The carbonate (CO₃) content of serpentine was determined using a thermal gravimetric analyzer (TGA 500) by heating up to 950° C. The loss on ignition (LOI) was determined by drying the sample at 950° C. for 1 h in argon.

### Selection of Solvents

In order to find a suitable ammonium salt for leaching magnesium from serpentine, ammonium chloride (NH₄Cl), ammonium sulphate ((NH₄)₂SO₄) and ammonium bisulfate (NH₄HSO₄) were tested alongside traditional solvent sulphuric acid (H₂SO₄) for comparison of efficiencies. In previous studies, promising results have been reported with dissolution of serpentine in strong acid (HCl, H₂SO₄, HNO₃), sulphuric acid gave the highest extraction efficiency of magnesium [10]. A batch of 20 g of serpentine (75-150 μm) was dissolved in 400 ml aqueous solutions of 2M concentrations of respective solvent in a sealed flask. The solutions were stirred at 800 rpm at a temperature of 70° C. The solutions were immediately filtered with 0.7 μm Pall syringe filters after 3 hours dissolution. The concentrations of Mg, Fe, and Si in the filtered solutions were measured with ICP-AES.

Magnesium Extraction from Serpentine

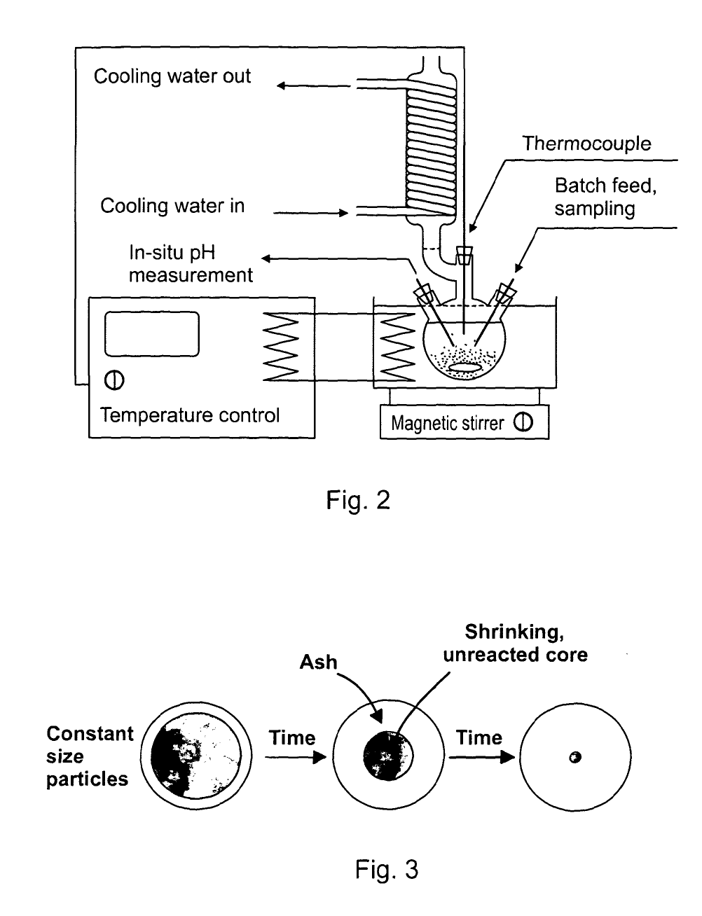

Extraction experiments were carried out in a 600 ml 3 necks glass flask reactor, which is heated by a temperature-controlled silicon oil bath and equipped with a water-cooled condenser to minimize solution losses due to evaporation (FIG. 2). The solutions were well mixed by using a magnetic stirrer setting to 800 rpm. A pH probe with digital meter was set up to in-situ measure the pH change during the course of experiment. During experiments, ml of desired solution was added to the flask, a charge 20 grams of serpentine with a particle size fraction of 75-150 μm was added into a certain concentration of solution until reaching the pre-determined temperature. After that, liquid samples would be extracted with a syringe at interval time, such as min, 15 min, 30 min, 1 h, 2 h, and 3 h. The samples are then immediately filtered with 0.45 μm syringe filter unit. The Mg, Fe and Si concentrations of the samples are measured using ICP-AES. During the whole course of dissolution, the pH values are measured on-line and recorded, the compensation of pH at different temperature is automatically done by the digital pH meter. At the end of reaction time, solution will be cooled down to ambient temperature and filtered with glass microfibre 0.7 μm syringe filter. The solid will be dried in the oven at 75° C. for overnight as product 1. The results from the ICP-AES analyses showed the concentrations of dissolved magnesium, iron, and silicon in the samples extracted during the course of the experiments. The extraction fraction of a specific element x (magnesium, iron or silicon) in solution sample at y time (at 5, 15, 30 mins) was calculated as follows:

$${X}_{Extraction} \% = \frac{{C}_{y} \times V}{{m}_{batch} \times {w}_{x}} \times 100 \% \qquad ( Eq . 6 )$$

C_{y} is the concentration of element x in the solution sampled at y time, V is the volume of the solution in the reactor (each sampling will extract 1 ml solution, but this minor volume is ignored), m_{batch} is the mass of serpentine sample added. wₓ is the weight percentage of mass of element x over the total mass of solid (this result report from the elemental analysis of raw serpentine).

### Kinetic Analysis

In a fluid-solid reaction, the reaction rate is generally controlled by the following sequential steps: diffusion through the fluid film, diffusion through the layer on the particle surface, or the chemical reaction at the surface. The rate of the reaction is controlled by the slowest of these steps [11].

In order to determine the kinetic parameters, such as reaction factor and activation energy, and rate-limiting step in this dissolution of serpentine by using ammonium salts, the experimental data was analyzed according to the standard integral analysis method [11]. The unreacted-core models of constant size (i.e. product layer stays on particle, FIG. 3) was selected since previous study have reported the incongruent dissolution of serpentine and have proved the existence of silicon layer after dissolution [12]. Experimental data were fitted into integral rate equations of film diffusion control, product layer diffusion control, and reaction control for constant size particles (flat plate, cylinder and sphere). The multiple regression correlation coefficients (R²) were calculated for each equation and checked graphically. The rate-limiting step of the reaction has the best multiple regression correlation coefficient when data were fitted to rate equation.

### Results and Discussion

### Characterization of Serpentine Sample

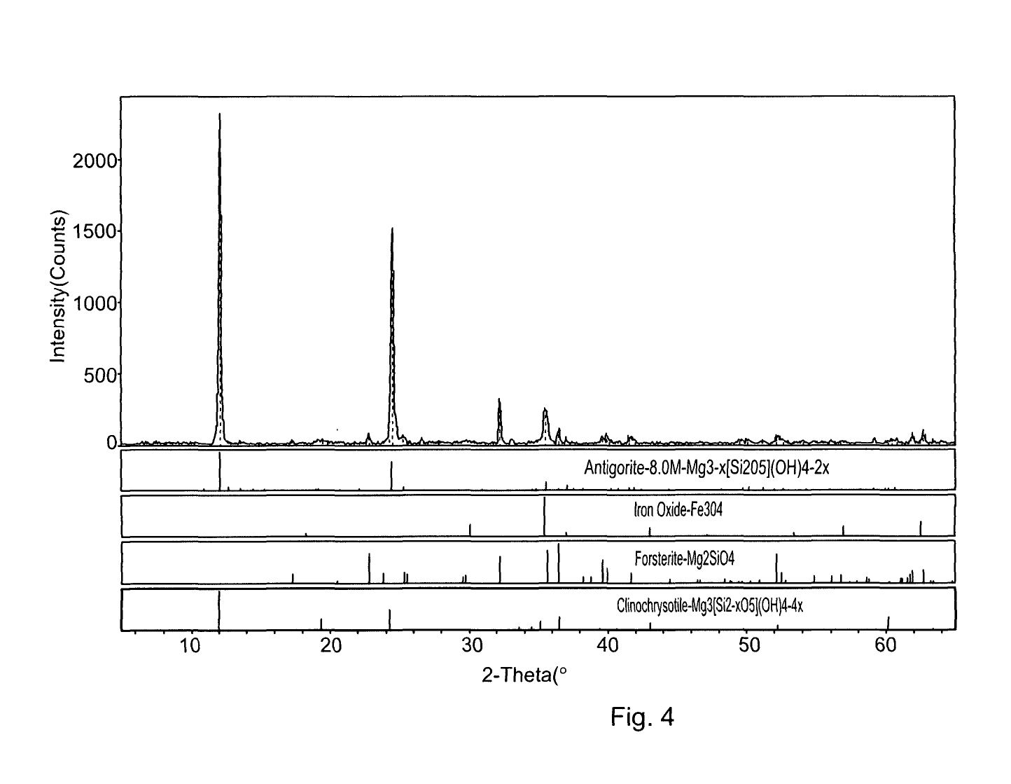

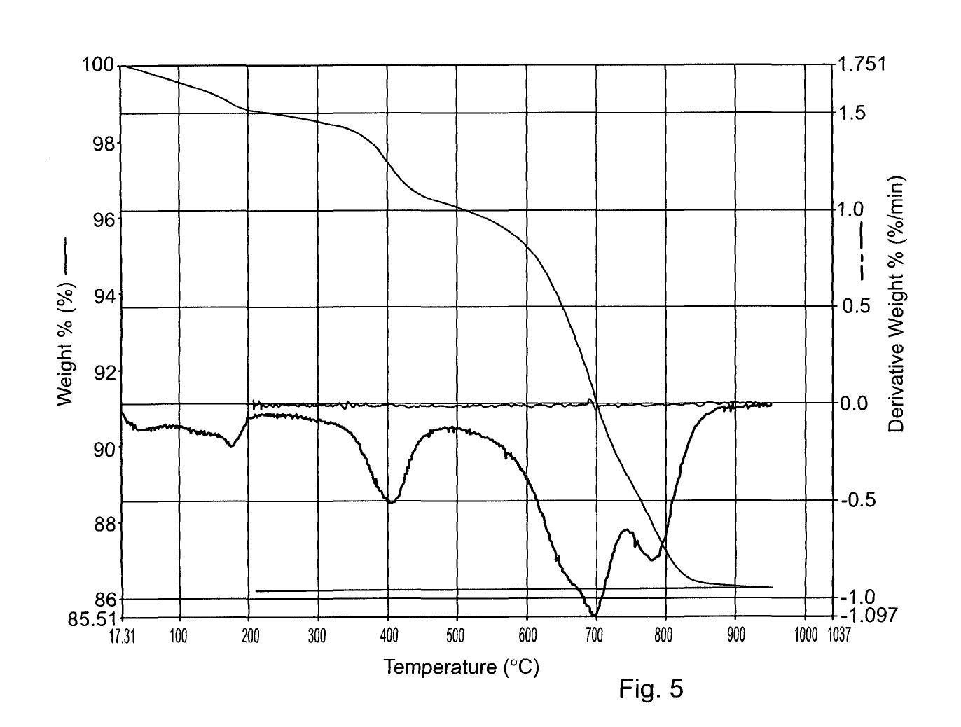

The elemental composition result from the serpentine dissolution analyses (microwave digestion and ICP-AES) is shown in Table 2. Major elements were Mg, Si and Fe, minor elements were Mn, Ca, Al and Ni (concentrations of 0.1-0.3 wt. %). The XRD pattern (FIG. 4) of the serpentine reveals that the rock contained serpentine, (Mg₃Si₂O₅(OH)₄; antigorite and chrysotile), forsterite (Mg₂SiO₄) and magnetite (Fe₃O₄). According to the TGA analysis (FIG. 5) the serpentine contained trace carbonate (1.12 wt. %), the loss on ignition at 950° C. was 13.6 wt. %, the moisture content was 0.6 wt. % and chemical-bound water was 11.88 wt. %. A summary of the results from serpentine characterization indicate that this serpentine sample is representative and suitable for CO₂ mineralization.

### Selection of Solvents

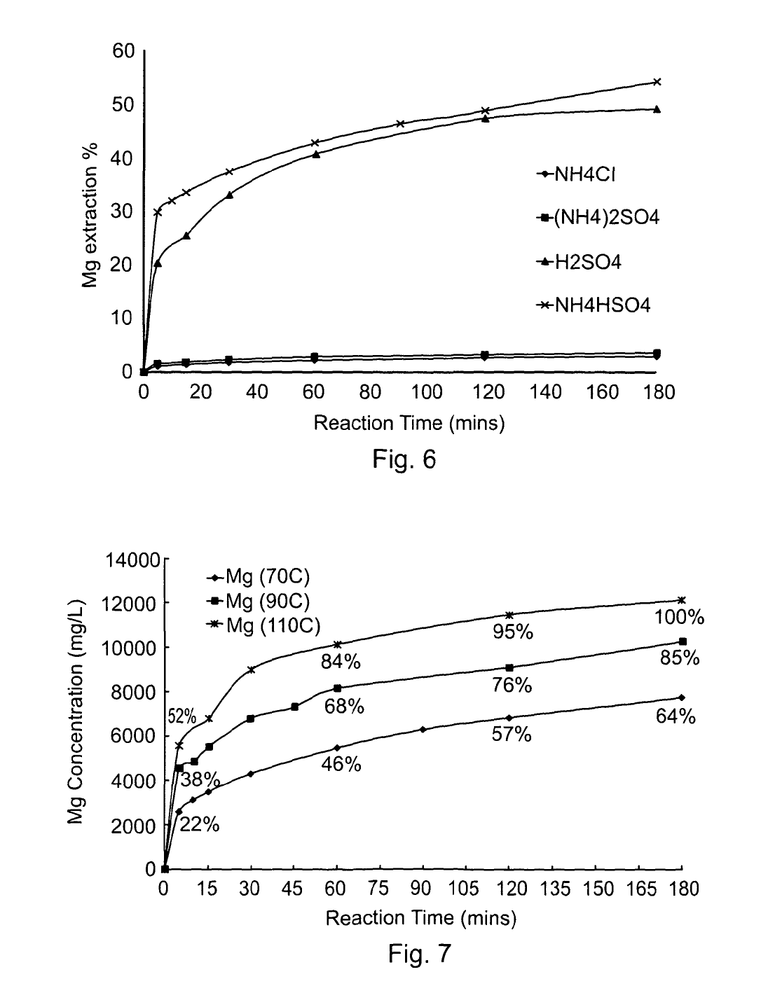

Calcium and magnesium are good candidates for mineral sequestration. Since serpentine contained very low concentrations of calcium, only the concentrations of magnesium extracted were interesting here. The magnesium extraction efficiencies of different solvents on dissolution of serpentine are shown in FIG. 6. According to the results presented, the solution of NH₄HSO₄ can extract significant amount of magnesium from serpentine (52%), NH₄Cl and (NH₄)₂SO₄ can only extract a little amount (3-5%) of magnesium from serpentine in 3 hours. The parent dissolution experiment with sulphuric acid was carried out in comparison with ammonium salts. The result indicated that ammonium bisulphate can extract more magnesium than sulphuric acid. In addition, it is found that longer reaction time resulted in more magnesium ions dissolved.

### Dissolution Studies of Serpentine in Selected Solvent

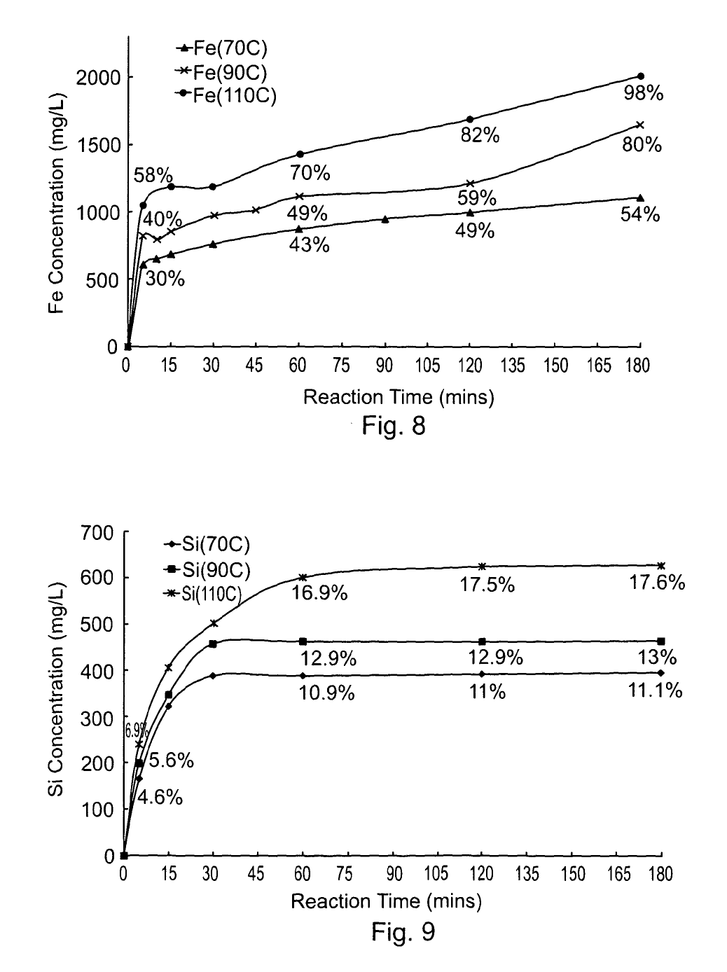

Based on the results from the experiments described above, NH₄HSO₄ was selected for further studies. The dissolution rate of serpentine with a particle size fraction of 75-150 μm was tested in 1.4 M (which is 40% excess of stoichiometric amount of NH₄HSO₄, was used to result in a more complete reaction) concentrations of NH₄HSO₄ using solution temperatures of 70° C., 90° C., and 110° C. respectively. The effect of temperature upon the dissolution of serpentine is shown in FIGS. 7-9. As can be seen from the figures, higher temperatures yield higher extraction efficiencies for each element tested. At 110° C., NH₄HSO₄ was able to extract 100% of magnesium from serpentine in 3 hours, simultaneously 98% of iron in serpentine was extracted. However, only 17.6% of silicon in serpentine was dissolved (FIG. 7). Apparently, magnesium and iron are extracted leaving behind mostly silica. This incongruent leaching could create a passive silicon layer on the surface of particle, and the layer could block the continue leaching of magnesium and iron from the inside of particles. That's why the dissolution rate becomes slow after fast dissolution at first 15 mins.

The effect of temperature upon the extraction efficiency was investigated by performing extraction experiments of serpentine at 70° C., 90° C. and 110° C. A solution concentration of 1.4M NH₄HSO₄ was selected for study. The results from the ICP-AES analyse (FIGS. 7-9) showed that temperature has a significant effect upon the solubility of magnesium (and other elements as well) from serpentine. At 70° C. the extraction is significantly slower than at 90° C., and a better magnesium extraction can be achieved. At 110° C. the extraction process is faster than at 90° C., and all magnesium can be extracted. Apparently the solubility of serpentine increases with higher temperatures. Meanwhile, this can be further improved by increasing the additive concentration in the aqueous solution.

After extraction experiments, it was found that the dissolved silicon content of the extraction solution was significantly reduced after cooling and filtration. For example 3 hours dissolution of serpentine with a particle size fraction of 75-150 μm at 110° C. in an aqueous solution of 1.4 M NH₄HSO₄, we observed that the silica dissolved in the solution forms a gel during the cooling and filtration. It also can be indicated by the concentration difference between the sample solution at 3 hours and filtrate sample after cooling and filtration (see Table 3).

To produce a solution suitable for precipitation of MgCO₃, high concentration of magnesium but low concentration of other elements is preferred. The composition of the produced magnesium-rich solution after filtration is shown in Table 3. As can be seen from the table, it is possible to minimize the content of silicon in the solutions, and removing the formed silica gel by filtration. However, iron and other elements (calcium, aluminium, manganese, chromium, copper, nickel and zinc) are needed to be removed from solution so as to get pure product in carbonation step.

### Kinetics Analysis

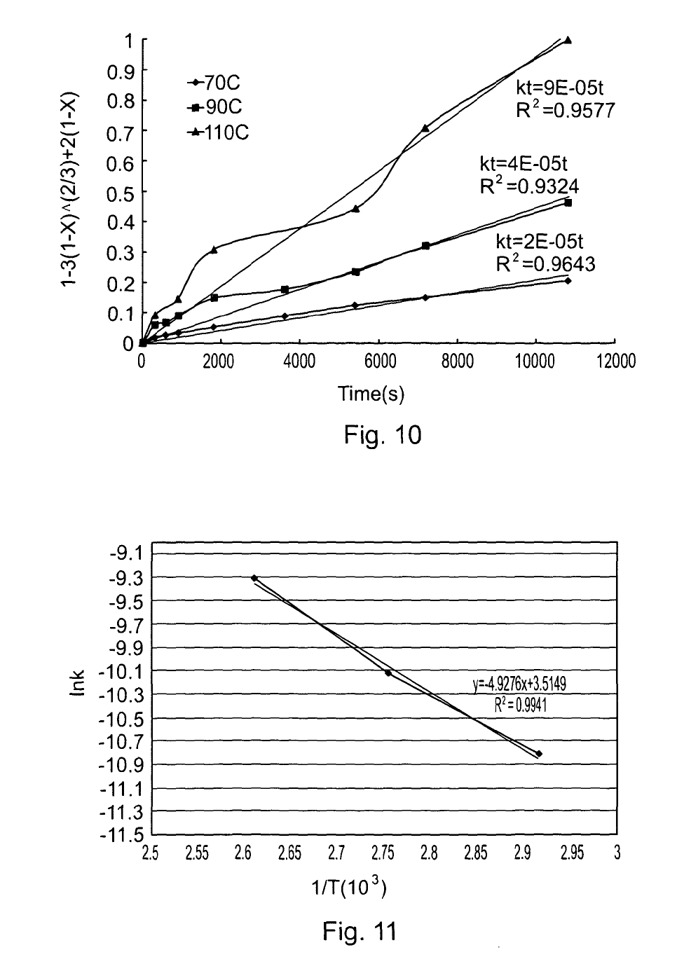

Kinetic analysis was performed based on experimental data for extraction of magnesium from serpentine (Table 4). Fitting the experimental data towards the integral rate equations, product layer diffusion gave the best match based on the regression correlation coefficients calculated (FIG. 10). However, the points derived from the experimental data do not perfectly match the trendline equation. In terms of positive deviation (those data points above the kinetic model equation), it may be explained by build-up of a passive silicon product layer. At the initial stage of the dissolution, the reaction rate is fast; with the reaction proceeds, due to incongruent leaching of silicon, the silicon product layer builds up, the reaction rates become slowly. Besides that, it may also be partly due to an initial temperature rise in solution since the dissolution reaction of serpentine is exothermic. The heat released from reaction can promote rapid dissolution of serpentine. For the negative deviation of experimental data fitted to the kinetic model, it may be due to a decreasing additive concentration at high dissolution levels. For example, roughly 50% of NH₄HSO₄ is consumed after a 80% extraction of magnesium from serpentine. For the errors, they might due to variation in serpentine composition or the mass loss during the sample feed or the evaporation of solution. A larger scale the experiment could reduce those errors.

The apparent rate constant (k) was determined from the slope of the lines in FIGS. 10. The apparent rate constant can be used for determining the activation energy (E) by Arrhenius' law:

k=k₀e^{-E/RT}

By plotting the apparent rate constants for each experiment at different temperature in an Arrhenlus plot (FIG. 11), the activation energy was determined and the results are shown in Table 5. There is no previous study for dissolution of serpentine in ammonium salts, but studies for dissolution of serpentine in strong acids could be used for comparison.

The activation energy found in this study is similar to the value calculated by Fouda et al. [13] for dissolution of serpentine in 3M H₂SO₄ between 30-75° C. (Table 5). But it is much lower than Teir's [1] value reported for dissolution of serpentine in 2M H₂SO₄ between 30-70° C. (Table 5). The results (FIG. 10) indicate that the rate limiting step for dissolution of serpentine in NH₄HSO₄ is product layer diffusion. Luce [14] found that a product layer is the rate-controlling mechanism for dissolution of magnesium silicates. Apostolidis and Distin [15] have also found that the rate was limited by diffusion through a silica passive layer when the magnesium extraction is above 25%. Our results are in agreement with them and the finding of low concentration of silicon in leaching solution supports the theory of a build up of a product layer of silica on the particles. While there is another explanation proposed by Teir, the chemical reaction is rate limiting at the beginning of the reaction, product layer diffusion gradually becoming rate limiting with the builds up of product layer of silica and the decrease of unreacted surface area. The evidence is that the activation energy should be rather low for a pure diffusion controlled process. In this study, the results also show that the process is very temperature sensitive and the activation energy is of the order of 40.9 kJ mol⁻¹, which is high for a layer diffusion controlled process. The observed activation energy is roughly one half of that for a pure chemical reaction [11]. These suggest that the true activation energy of serpentine dissolution for chemical reaction control would be around of the order of 80 kJ mol⁻¹. In summary of above, the rate limiting mechanism of serpentine dissolution with NH₄HSO₄ is a chemical reaction with product layer diffusion control.

Pre-treatment of serpentine could further enhance the dissolution rate. For example, the serpentine, or other mineral source material, could be broken into smaller pieces. Physical activation such as concurrent grinding could effectively remove the silica layer from the particles [16]. Studies have also shown heat-treatment at 650° C. increase reactivity greatly [17]. However, physical and thermal activation of the mineral increases considerably the energy demand of the process.

CO₂ mineralization is an interesting option for long-term storage of CO₂. Our new pH-swing mineral carbonation process by using ammonium salts could remove the barrier of recycling of all chemicals involved. And this process could combine capture and storage together to save CO₂ compression and transportation steps. If the by-products from this process reach high purity, it would compensate the cost of CO₂ sequestration.

The experiments of solvent selection performed shows that NH₄HSO₄ can extract significant amount of magnesium from serpentine and its extraction efficiency is even better than using sulphuric acid. The results from extraction experiments shows that at 110° C. 1.4 M NH₄HSO₄ was able to extract 100% of magnesium from serpentine in 3 hours, simultaneously 98% of iron, but, only 17.6% of silicon. This incongruent leaching could create a passive silicon layer on the surface of particle to block continue leaching of magnesium. In addition, it is found that the solubility of serpentine increases with higher temperatures. The produced Mg-rich leaching solution is suitable for precipitation of MgCO₃ after removing the impurities.

The dissolution of kinetics were found to follow the model of constant size particles, the rate limiting mechanism of serpentine dissolution with NH₄HSO₄ is a chemical reaction with product layer diffusion control. In this study, the results show that the serpentine dissolution with ammonium bisulfate is very temperature sensitive and the activation energy is of the order of 40.9 kJ mol⁻¹, which is in agreement with the previous kinetic studies of magnesium extraction from serpentine.

### Further Example Tests

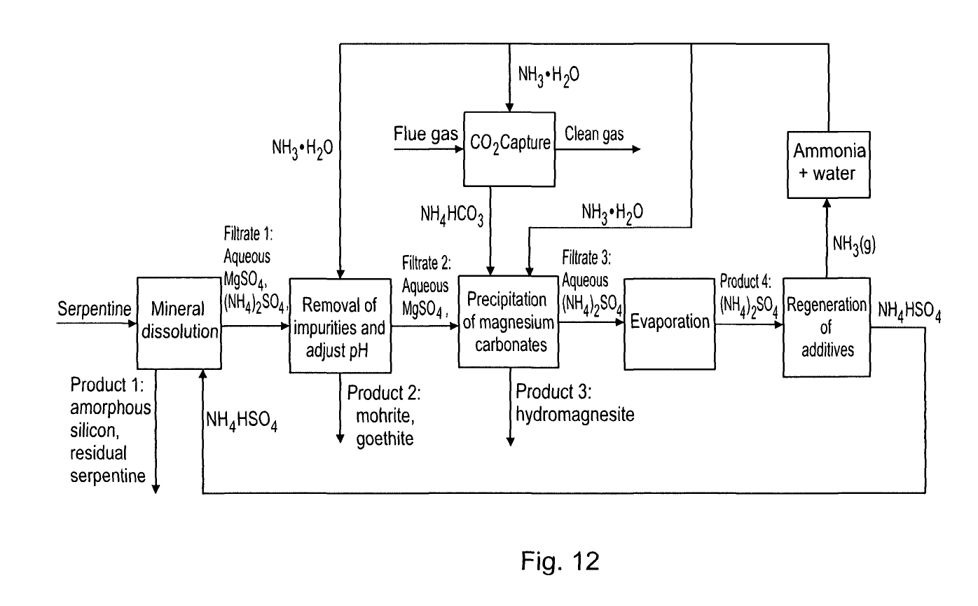

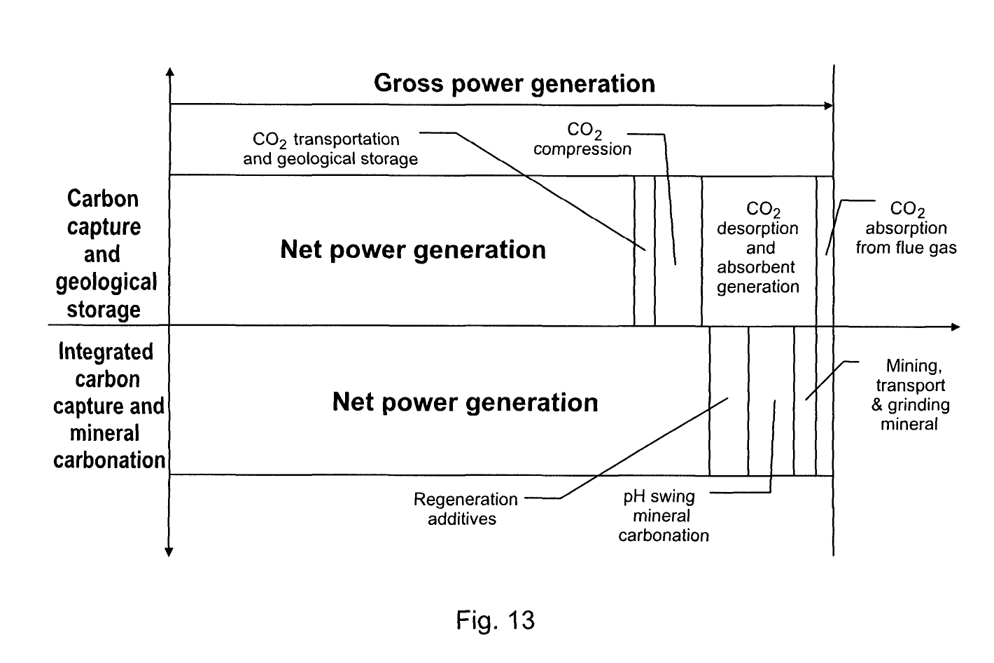

A modified process diagram can be seen in the FIG. 12. In this process, aqueous NH₄HSO₄ was used to extract Mg from serpentine. Then the pH of the solution is swung by adding ammonia water, resulting in Fe and Si precipitating from solution. NH₄HCO₃ and NH₃ were then added into solution to react with Mg and produce carbonates and (NH₄)₂SO₄, that was recycled from the solution by evaporation and then decomposed back into NH₃ and NH₄HSO₄.

Carbonation with NH₄HCO₃ and the NH₄HSO₄ and NH₃ regeneration from the by-product of carbonation has been investigated. The results of the pH regulation of prepared Mg solution from dissolution, carbonation experiments and regeneration of ammonium salts by thermal decomposition are presented. The carbonation experiments were conducted at different molar ratios of Mg—NH₄HCO₃—NH₃ to examine the carbonation efficiency.

Preparation of Magnesium Salt Solutions from Serpentine Using NH₄HSO₄

The dissolution experiments discussed above showed that NH₄HSO₄ is suitable for extracting magnesium from serpentine. The chemical equation for dissolution of magnesium from serpentine using NH₄HSO₄ is:

Mg₃Si₂O₅.(OH)₄+6NH₄HSO₄→3MgSO₄+2SiO₂+5H₂O+3(NH₄)₂SO₄

For the dissolution experiments, the same procedure was followed as described in previously in [32]. Different temperatures (80° C., 90° C. and 100° C.) and reaction time (1 h, 2 h and 3 h) were used in preparation of MgSO₄ solutions. After dissolution, the solution was cooled down to room temperature and filtered using a 0.45 μm Pall syringe filters. The filtrate is referred to as filtrate 1 and was used for the pH regulation studies. The solid residue was dried at 105° C. overnight and is referred to as product 1. The filtrate 1 was sampled and acidified by 70 wt % HNO₃ for preventing precipitation of Mg and Fe, the concentration of dissolved Mg, Fe and Si were measured using ICP-AES. The product 1 was sampled and sent for XRF analysis to determine the weight % of Mg, Fe and Si.

### pH Regulation and Removal of Impurities

About 40% excess NH₄HSO₄ was used for the dissolution in order to maximise the magnesium extraction. After the dissolution, the pH values of the solution were about 0.9˜1.2. As the carbonation reaction is favourable at high pH values, it was necessary to increase the pH of the solution to alkaline values. The chemical reaction of the pH regulation is:

NH₄HSO₄+NH₃.H₂O→(NH₄)₂SO₄+HO₂O

The reason for using ammonia water is because the above reaction produces ammonium sulphate, which can be converted to NH₃ and NH₄HSO₄ in the regeneration step to enable the recycling of the additives.

If high value product (e.g. pure magnesium carbonate) is wanted, some impurities, such as Fe, Al, Cr, Zn, Cu and Mn, need to be precipitated out from the system by increasing pH. In order to optimize the removal of impurities, extra ammonia water was added into filtrate 1 after pH regulation. The reactions for impurity removal are:

(Fe,Al,Cr)₂(SO₄)₃+6NH₃.H₂O→2(Fe,Al,Cr)(OH)₃↓+3(NH₄)₂SO₄(Zn,Cu,Mn)SO₄+2NH₃.H₂O→(Zn,Cu,Mn)(OH)₂↓+(NH₄)₂SO₄

In embodiments, during the pH regulation and removal of impurities, ammonia water (35 wt. %) was added into filtrate 1 until the pH value was neutral. During this process, the solution was stirred and an in-situ pH probe was used to measure the pH value. The solution was filtered with 0.7 μm Pall syringe filters. This filtrate is referred to as filtrate 2 and was used for the carbonation experiments. The solid residue was dried at 105° C. overnight and is referred to as product 2. The filtrate 2 was analyzed by ICP-AES to quantify the concentration of different elements, including Mg, Si, Fe, Mn, Zn, Cu, Al and Cr. The product 2 was analyzed by XRF and XRD to quantify its composition and identify the mineral phases present.

### Precipitation of Hydromagnesite Using NH₄HCO₃

The reaction of precipitation of hydromagnesite by reacting MgSO₄ with NH₄HCO₃ and NH₃ is:

MgSO₄+NH₄HCO₃+NH₃→MgCO₃↓+(NH₄)₂SO₄

During the carbonation experiments, the filtrate 2 was put in a 500 ml 3 necks glass vessel and heated up to 60° C. using a silicon oil bath. The experimental setup was as reported in the previous paper [32]. The time, temperature and pH values were recorded every 5 mins during the whole experiments. Before starting to heat, ammonia water (35 wt. %) was added into filtrate 2. When the temperature reached 60° C., NH₄HCO₃ (as CO₂ source) was added and the solution was heated to 90° C. 2 ml aliquots were sampled using a needle syringe at 5, 10, 15, 30, 45 and 60 mins. The liquid samples were filtered by a mini filter unit and acidified with HNO₃. The liquid samples were analyzed by ICP-AES to measure the change of magnesium concentration. After the solution was stabilised at 90° C., the solution was kept at that temperature for mins. After that, the solution was cooled down and filtered with 0.7 μm Pall syringe filters and the filtrate is referred to as filtrate 3. The solid residue was dried at 105° C. overnight and is referred to as product 3. The composition of the product 3 was analyzed using XRF and the mineral phases were identified by XRD. The carbon content of the product 3 was measured by TGA. Experiments were conducted at different mass ratios of Mg:NH₃: NH₄HCO₃, where Mg is the mass of Mg in filtrate 2, NH₃ is the mass of ammonia water added and NH₄HCO₃ is the mass of NH₄HCO₃ added. The matrix of the experiments conducted at different mass ratios is listed in Table 1.

### The Carbonation Efficiency is Defined as Follows:

$$Carbonation efficiency ( \% ) = \frac{{CO}_{2} content ( wt \% ) \times 24 \times {m}_{3}}{44 \times {c}_{2} \times {V}_{2}} \times 100$$

Where CO₂ content (wt. %) is the weight loss of product 3 during the temperature range from 300° C. to 500° C. corresponding to carbonate decomposition from the TGA studies [33]. m₃ is the mass (grams) of product 3 from carbonation experiment, c₂ is the magnesium concentration in filtrate 2 from ICP-AES and V₂ is the volume of filtrate 2, 24 and 44 is the molecular weight of Mg and CO₂.

### Thermal Decomposition of (NH₄)₂SO₄

The filtrate 3 was evaporated by using a rotary evaporator at 60° C. for 15 mins. The solid was collected from the rotary evaporator and is referred to as product 4. The regeneration of NH₄HSO₄ and NH₃ was conducted by thermal decomposition of product 4 in an oven at 330° C. and the reaction is

(NH₄)₂SO₄→NH₄HSO₄+NH₃↑

The thermal decomposition of product 4 was performed on a thermal gravimetric analyzer (TGA Q500) in the temperature range of 30-530° C. with a constant heating rate of 10° C./min under nitrogen atmosphere. The temperature programme was as follows: from 30° C. to 230° C. at rate of 10° C./min, hold for 10 mins at 230° C., up to 330=C at rate of 10° C./min, hold for mins at 330° C. and finally up to 530° C. at rate of 10° C./min. The application of three steps heating can help to find the clear thermal decomposition temperature range and avoid the mixture decomposition of products. In order to validation of product 4 to be (NH₄)₂SO₄ and generation of NH₄HSO₄ from product 4, the weight loss of pure (NH₄)₂SO₄ and NH₄HSO₄ were also characterised by TGA analysis using the same heating procedure.

### Results and Discussions

Preparation of Magnesium Salts Solutions from Serpentine Using NH₄HSO₄

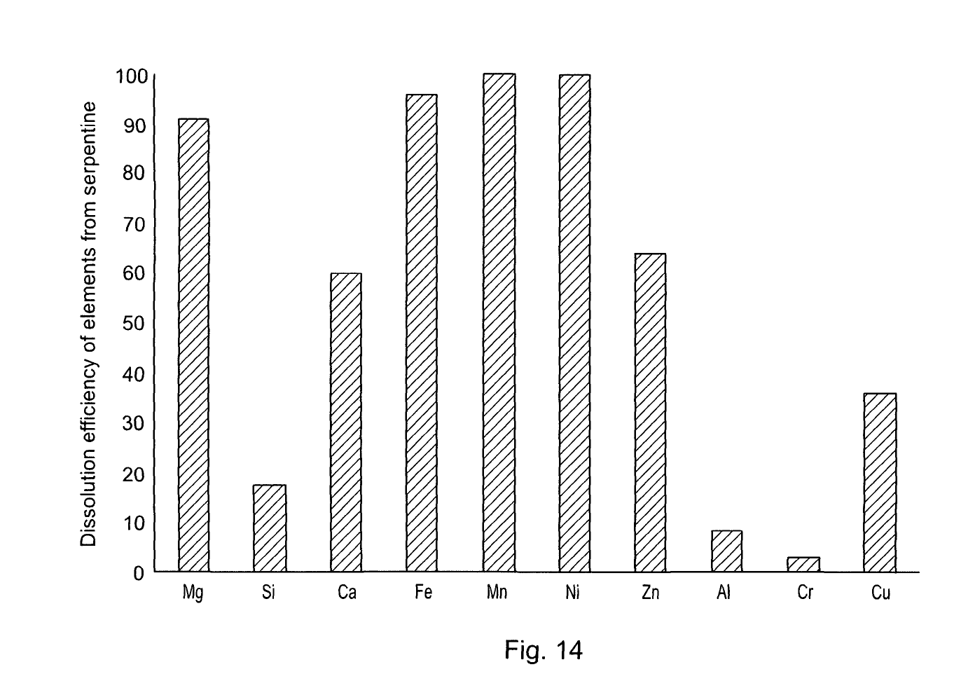

The results from the ICP-AES analyses (Table 7) of the filtrate 1 solutions show that high concentration of Mg and Fe were extracted from serpentine, while small amounts of Si were dissolved. Taking experiment 3 as an example, using the data in Table 7, the dissolution efficiency of Mg from serpentine was 91% using 1.4 M NH₄HSO₄ at 100° C. for 2 h. The definition of dissolution efficiency is the percentage of dissolved Mg in filtrate 1 solution over Mg in parent serpentine. The dissolution efficiency of elements is stated in FIG. 14. It is found that 96% Fe, 17% Si, 100% Ni and Mn, and some Ca, Zn, Cu and Al were also extracted from serpentine. This result is consistent with the previous dissolution studies, where the dissolution efficiencies of Mg, Fe and Si from serpentine were 95%, 83% and 17% respectively under the same experimental conditions [32]. As high purity MgCO₃ is desired, all the other cations are considered as impurities, with Fe and Si being identified as the main impurities and reported in Table 7. Magnesium was removed from serpentine, leaving behind amorphous silica. This can be explained by incongruent dissolution of Mg and Si as previously discussed, where chemical reaction with product layer diffusion control was found to be the rate limiting step of serpentine dissolution in NH₄HSO₄.

### pH Regulation and Removal of Impurities

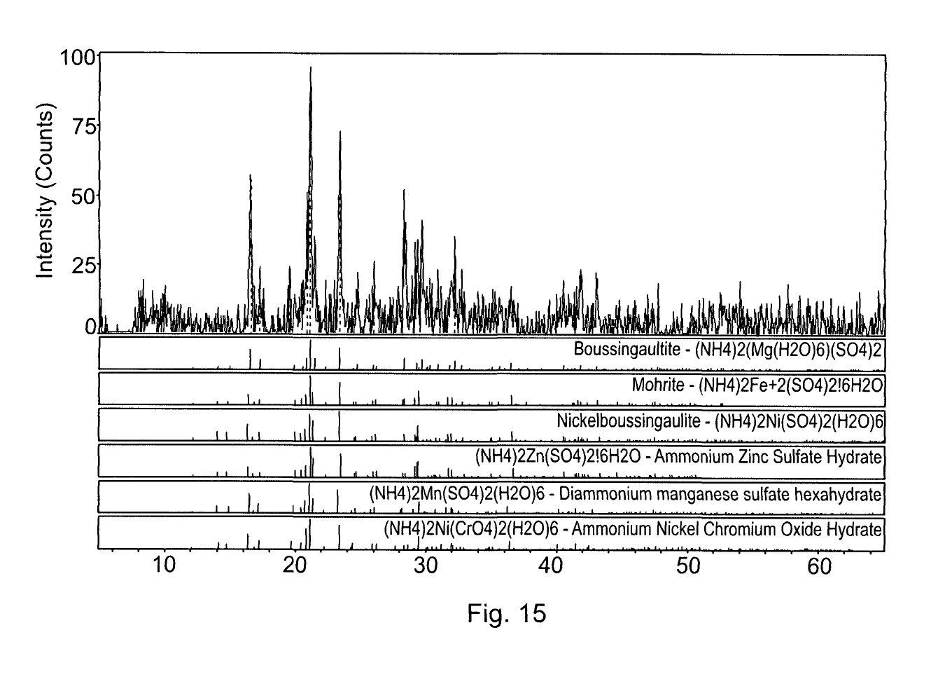

It was found that after adding ammonia water to the filtrate 1 solution, black and brown particles precipitated. After filtering and drying overnight at 105° C., the black solid was labelled as product 2 and the resulted filtrate as filtrate 2. Ammonia water (35 wt. %) was then added to filtrate 2 until the pH value reached 8.5. Table 3 presents that product 2 consists mostly of 19.23% Fe, but also 8.17% Si and 2.79% Mg in experiment 7. The XRD pattern of product 2 (FIG. 15) identified double ammonium salts, (NH₄)₂Fe₂(SO₄)₂.6H₂O, (NH₄)₂Mg₂(SO₄)₂.6H₂O and (NH₄)₂Zn₂(SO₄)₂.6H₂O, to be the major phases. The presence of these double ammonium salts results from the excess of ammonia water. Hot water flashing can decompose these double ammonium salts into ammonium sulphate and insoluble hydroxide salts [34]. Table 7 clearly shows that the concentration of Fe in filtrate 2 decreased significantly compared to filtrate 1. This decrease of Fe concentration indicates that Fe precipitates. The results of XRF, ICP-AES and XRD analysis in Table 7, Table 8 and FIG. 15 are consistent with this observation, indicating that a high Fe content precipitate was produced. Magnesium also precipitated during this procedure, causing the filtrate 2 to contain 5% less dissolved magnesium than filtrate 1.

### Precipitation Studies

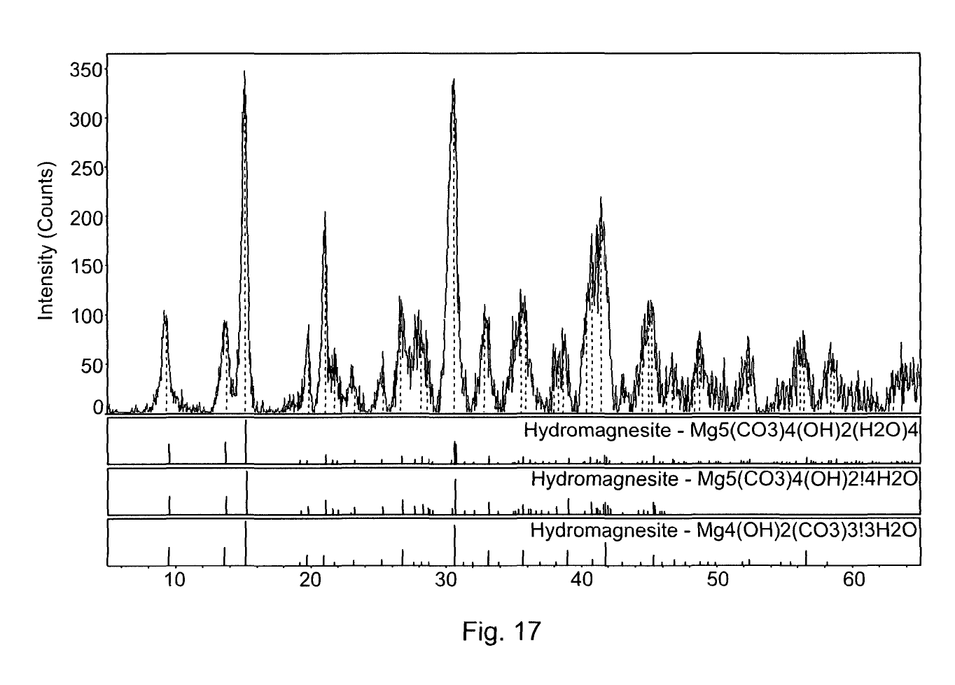

10 precipitation experiments were carried out at different mass ratio of Mg:NH₃: NH₄HCO₃, as shown in Table 6. The observations and findings from these 10 experiments were similar in terms of carbonation and morphology of the products. Taking product 3 of experiment 7 as an example, the FIG. 17 indicates the presence of magnesium carbonate. This corresponds to the decrease of Mg concentration in solution give values to Table 7 and 8.

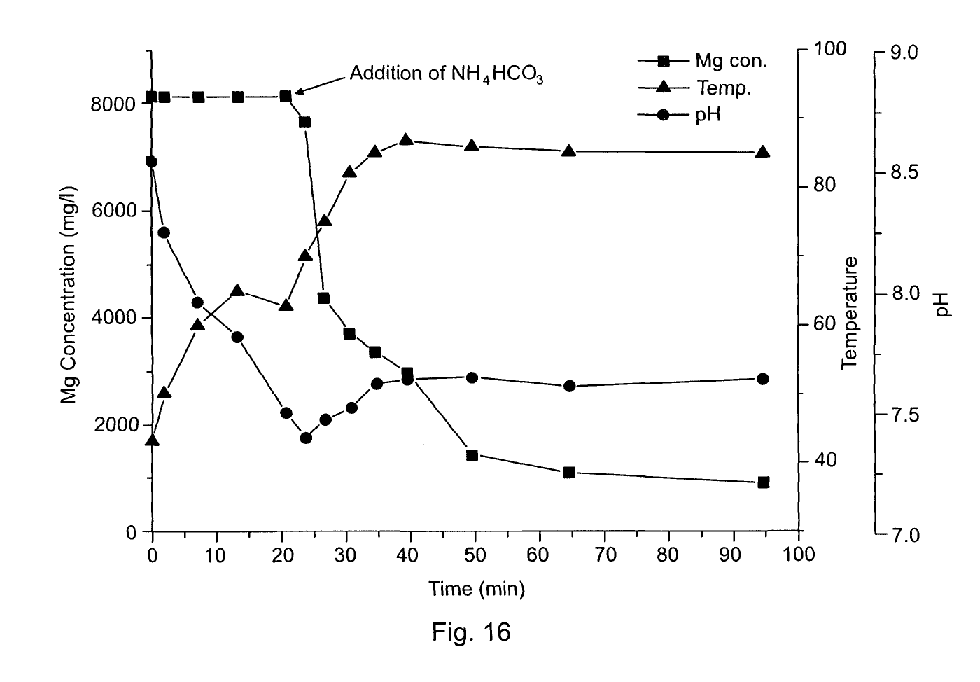

FIG. 16 shows the Mg concentration changes with time and temperature in experiment 7. The starting time is when heating is started, the pH of filtrate 2 decreased from 8.5 to 7.3 when the temperature was increased during the first 20 mins. When NH₄HCO₃ was added the filtrate 2 solutions at 60° C. as labelled in FIG. 16, the pH increased slightly to 7.6. No precipitate was formed before adding NH₄HCO₃. The concentration of magnesium started to drop when the temperature went up to 70° C. at the 25^{th} minute. In the following 5 mins, half of the Mg ions precipitated at a very high rate of 33.3 mmol/min. When the temperature was stabilised at 85° C. at the 40^{th} minute, the pH became stable and the Mg precipitated at a constant rate of 7.9 mmol/min. After 25 mins counted from addition of NH₄HCO₃, the concentration of Mg in solution became steady and finally went below 1000 mg/l.

For product 3 of experiment 7, the XRD pattern (FIG. 17) showed that the Mg precipitated as hydromagnesite, Mg₅(CO₃)₄(OH)₂.4H₂O. Combining the results from XRF of product 3 (Table 8) and ICP-AES of filtrate 3 (Table 7), it can be concluded that product 3 is a high purity hydromagnesite with 0.79 wt % of Fe and 0.29 wt % Si.

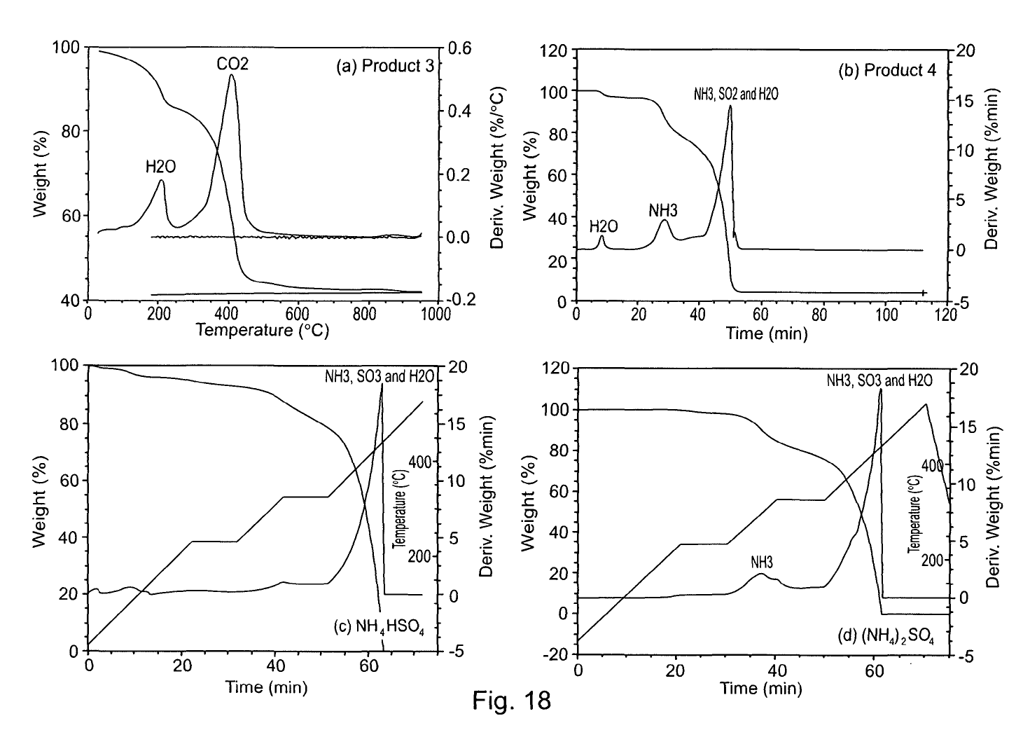

The carbon content of product 3 could be calculated from the TGA profiles (FIG. 18(a)). All samples contained only one carbonate phase according to XRD studies. Therefore, the mass of the identified carbonate phase was estimated based on the corresponding weight loss from the TGA studies. As an example, FIG. 18 (a) shows two peaks, where the first peak below 250° C. is about 12 wt. % and corresponds to the release of crystal water [33]. The second peak is due to the release of CO₂ and accounts for 37 wt. % [33]. It can be seen from the TGA graph that the hydromagnesite does not decompose until 300° C. Finally, based on the CO₂ content (Table 8) and the Mg concentration in filtrate 2 (Table 7), it can be calculated that the carbonation efficiency of experiment 7 is 90%.

During the carbonation step, the Mg ions firstly react with HCO₃⁻ to form Mg(HCO₃)₂. Mg(HCO₃)₂ then thermal decomposes into insoluble MgCO₃ at elevated temperature. In the thermal decomposition reaction of Mg(HCO₃)₂ into MgCO₃, 1 mole of magnesium bicarbonate ion can convert into 1 mole of magnesium carbonate and 1 mole of CO₂. This means that the maximum stoichiometry carbonation efficiency is only 50%. As an example in preliminary experiment where no NH₃ was used (Table 6), the carbonation efficiency was only 25.5%. However, the joint use of ammonia water and NH₄HCO₃ can improve the carbonation, as explained by the following reaction equations:

Mg(HCO₃)₂→MgCO₃↓+H₂O+CO₂↑

NH₃(a)+CO₂(g)+H₂O→NH₄HCO₃

NH₃+NH₄HCO₃→(NH₄)₂CO₃

MgSO₄+(NH₄)₂CO₃→MgCO₃↓+(NH₄)₂SO₄

MgSO₄+2NH₄OH→Mg(OH)₂+(NH₄)₂SO₄

Mg(OH)₂+2CO₂→Mg(HCO₃)₂

Mg(OH)₂+Mg(HCO₃)₂→2MgCO₃↓+2H₂O

Ammonia captures CO₂ to regenerate NH₄HCO₃, where this reaction is already used in CO₂ capture technology [28]. Ammonia can convert NH₄HCO₃ into (NH₄)₂CO₃, which can directly produce MgCO₃. Ammonia can also react with MgSO₄ to form insoluble Mg(OH)₂ when the pH value is above 10 [26]. Once the CO₂ is released from the decomposition of Mg(HCO₃)₂, Mg(OH)₂ can react with CO₂ to form Mg(HCO₃)₂. Moreover, the Mg(OH)₂ can also react with Mg(HCO₃)₂ directly to precipitate MgCO₃. Therefore, the carbonation efficiency can be improved by addition of ammonia water to the high Mg concentration solution.

In the experiments 1-10, where ammonia water was added, the carbonation efficiency can reach 95.9% (Table 6).

Furthermore, it was found that the precipitation of magnesium ammonium carbonate (MgCO₃.(NH₄)₂CO₃.4H₂O) can reduce the carbonation efficiency. As described in the patent [36], MgCO₃.(NH₄)₂CO₃.4H₂O is generated from the reaction where NH₃ and NH₄HCO₃ react with Mg ions at low temperature. MgCO₃.(NH₄)₂CO₃.4H₂O can quickly precipitate by adding the NH₄HCO₃ below 60° C. However, MgCO₃.(NH₄)₂CO₃.4H₂O decomposes quickly to produce MgHCO₃, and NH₃ gas when temperature goes above 60° C. The reactions of production and decomposition of magnesium ammonium carbonate are presented here:

MgSO₄+NH₃HCO₃+NH₃+4H₂O→MgCO₃.(NH₄)₂CO₃.4H₂O↓MgCO₃.(NH₄)₂CO₃.4H₂O→Mg(HCO₃)₂+2NH₃↑+5H₂O

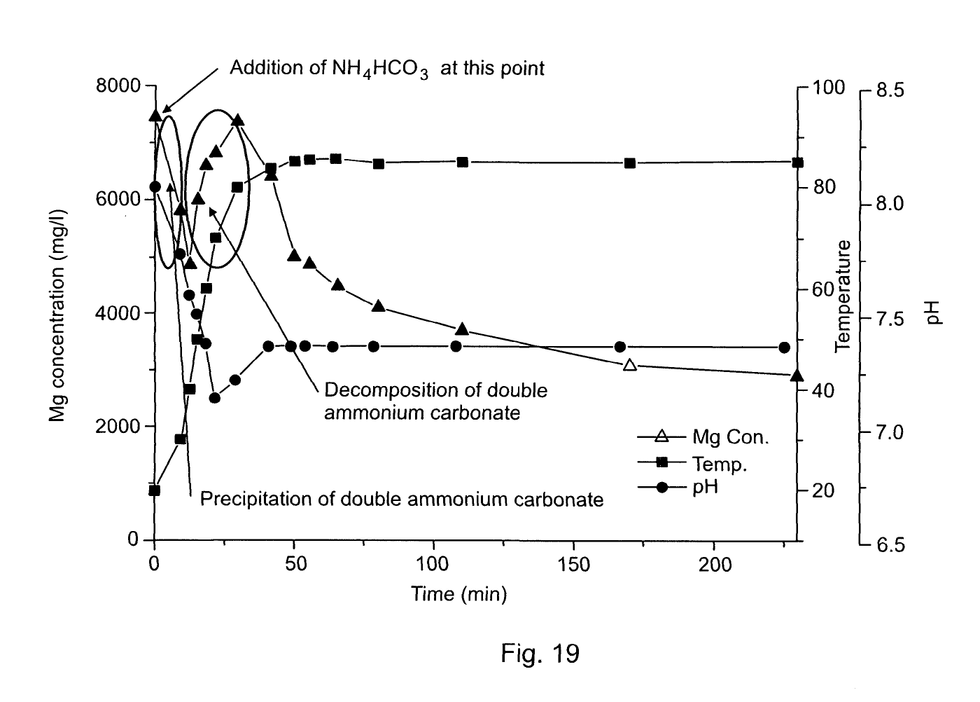

It can be seen from the above equation that NH₃ is produced from the aqueous solution, and this would decrease the carbonation efficiency due to shortage of NH₃. Therefore, the precipitation of MgCO₃.(NH₄)₂CO₃.4H₂O should be prevented in order to maintain high carbonation efficiency. Taking experiment 4 as example, the precipitation of MgCO₃.(NH₄)₂CO₃.4H₂O is indicated in FIG. 19. When the temperature increased above 60=C, the Mg concentration increases, indicating the decomposition of MgCO₃.(NH₄)₂CO₃.4H₂O. The subsequent decrease of Mg ions after 30 minutes indicates the precipitation of hydromagnesite. The carbonation efficiency of experiment 4 is as low as 53.4% due to the shortage of NH₃ gas which escaped from the reaction system during the thermal decomposition of MgCO₃.(NH₄)₂CO₃.4H₂O. Comparing experiments 4 and 9 using the same mass ratio of Mg—NH₄HCO₃—NH₃ and same experimental conditions, the carbonation efficiency decreased from 91.5% to 53.4% when there was precipitation of MgCO₃.(NH₄)₂CO₃.4H₂O (Table 6). Therefore, in order to prevent the low carbonation efficiency caused by precipitation of magnesium ammonium carbonate, NH₄HCO₃ should preferably be added into solution above 60° C.

Moreover, in order to compare this work with Pundsack's [28], carbonation experiments were carried out following his procedure. CO₂ was bubbled into the prepared high Mg concentration solution from serpentine and excess ammonia water was added. Only 35% carbonation efficiency was obtained. In comparison, the carbonation efficiency from this work can achieve a maximum of 95.9% (experiment 8) due to the faster reaction rate between NH₄HCO₃ and Mg.

### Thermal Decomposition of (NH₄)₂SO₄

Product 4 is obtained from the carbonation step by evaporating the filtrate 3. The product 4 was used to generate NH₃ and NH₄HSO₄ by thermal decomposition in oven at 330° C. for 20 mins. The released gas (NH₃), was collected using water to produce ammonia water. The solid residue after heating was NH₄HSO₄. These results were verified by conducting TGA studies, as described here. Studies of thermal conversion of ammonium sulphate to ammonium bisulphate can be found in several patents [37][38][39]. As an example in this study, the thermal decomposition of product 4 from experiment 7, as studied by TGA, is shown in FIG. 18 (b). It shows two peaks, where the first weight loss below 330° C. is about 21.7 wt. %, corresponding to the release of NH₃ and the formation of NH₄HSO_{4 [}37][38] [39]. The second weight loss is 75.8 wt. % and is due to further decomposition of NH₄HSO₄ between 350° C. and 500° C. [37] [38][39]. In total, the weight loss of product 4 is 97.5 wt. %, and the residual 2.5 wt % is due to the presence of MgSO₄ which did not react during carbonation. The similar TGA profile of pure (NH₄)₂SO₄ (purchased from Fisher Scientific) is presented in FIG. 18 (c), where two peaks appear at the same temperature range as those for the TGA profile of product 4 (FIG. 18 (b)). The TGA curve of NH₄HSO₄ is presented in FIG. 18 (d) and shows only one peak between 330° C. and 500° C. due to decomposition into NH₃, H₂O and SO₃. The NH₄HSO₄ and NH₃ regeneration efficiency from (NH₄)₂SO₄ has been reported to be nearly 97% [37][38][39]. In this work, the regeneration efficiency of NH₄HSO₄ and NH₃ from product 4 is 95%. These TGA results indicate that the reaction of thermal decomposition of (NH₄)₂SO₄ should preferably not be conducted above 330° C. to avoid further decomposition, since NH₄HSO₄ can decompose into NH₃, SO₃ and H₂O above 330° C.

### The Effect of Mass Ratio of Mg—NH₄HCO₃—NH₃ to Carbonation

The mass ratio of Mg:NH₄HCO₃: NH₃ is the key factor to control carbonation efficiency as discussed here. The stoichiometric molar ratio of Mg:NH₄HCO₃ is 1:2, but the results of experiment 5 show that when the ratio is 1:2, the carbonation efficiency is only 41.5% (Table 6). The increase of NH₄HCO₃ can improve the carbonation efficiency, as presented in Table 6, where the carbonation efficiency increase to 71.6%, 77.9% and 89.9% when the ratio of Mg:NH₄HCO₃ is 1:3, 1:4 and 1:5, respectively. This can be explained by the thermal decomposition of NH₄HCO₃ according to the below equation and reported by Zhang [35]. NH₄HCO₃ can regenerate NH₃ and release CO₂ when the temperature is above 70=C. The two reactions (precipitation of carbonate and decomposition of NH₄HCO₃) compete for NH₄HCO₃, and this may cause the low carbonation efficiency due to the shortage of NH₄HCO₃.

NH₄HCO₃+NH₃↓+CO₂↓+H₂O(

Besides, adding ammonia water can increase the carbonation efficiency as discussed above. In compassion with the preliminary experiment, experiments and 2 show that carbonation efficiencies increase from 25.5% to 53% and then 71.6% when the mass ratio of Mg:NH₄HCO₃: NH₃ increase from 1:3:0 to 1:3:0.5 and then 1:3:1. This trend was also found in experiments 6, 8 and 9. However, when the ratio of NH₃ increases to 1:4:3, the carbonation efficiency does not increase any further.

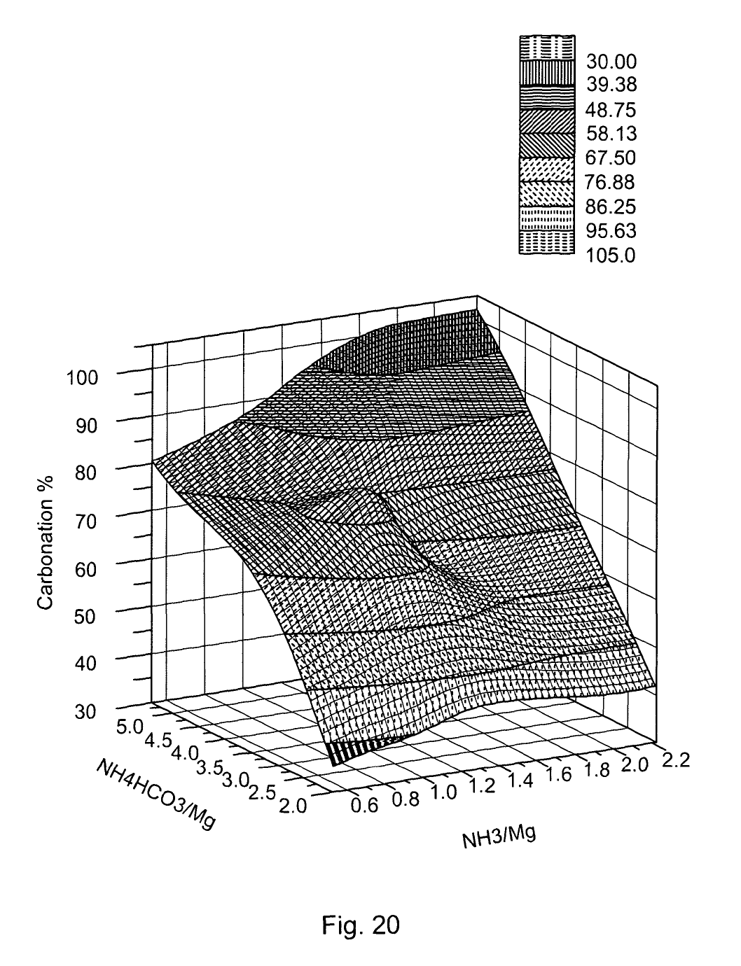

An optimum mass ratio of Mg:NH₄HCO₃:NH₃ was determined. The results are plotted into a 3D graph (FIG. 20) in order to show the relationship of the four variables, including mass of Mg, mass of NH₄HCO₃, mass of NH₃ and carbonation efficiency. FIG. 20 clearly shows that a low summit of 71.6% carbonation efficiency appears when the mass ratio of Mg:NH₄HCO₃: NH₃ is 1:3:1 and a high summit of 95.9% carbonation efficiency appears when the mass ratio of Mg:NH₄HCO₃: NH₃ is 1:4:2. Continuously increasing both NH₄HCO₃ and NH₃ does not result in a significant rise of the carbonation efficiency. However, an optimum amount of NH₄HCO₃ and NH₃ are needed to achieve the highest carbonation efficiency due to the loss of CO₂ and NH₃ in an open system.

The process studied here presents higher carbonation efficiency than that reported in previous work. For example, in Gerdemann's work [35], 64% carbonation efficiency was achieved in direct carbonation of heat treated serpentine at 155° C. and 115 bars in 0.64 M NaHCO₃ and 1 M NaCl solution. In Teir's work [36], the conversion of magnesium ions to hydromagnesite was 94% using HNO₃ and 79% using HCl at pH 9 with addition of NaOH (1.1 g NaOH/g precipitate). In this study, the highest carbonation efficiency is 95.9% at 85° C. and ambient pressure within 30 mins by joint usage of NH₄HCO₃ and NH₃.

### Mass Balance

Considering that the dissolution efficiency can achieve 90% at 100° C. and 2 h and that the carbonation efficiency is 95.9% when the molar ratio of Mg:NH₄HCO₃:NH₃ is 1:4:2, the net conversion of serpentine to hydromagnesite is 86.3%. To calculate the mass balance based on these efficiencies, about 2.63 t of serpentine, 8.48 t of NH₄HSO₄, 2.31 t of NH₄HCO₃ and 0.5 t of NH₃ are required to sequester 1 t CO₂, and 2.95 t of hydromagnesite is produced. If the 95% regeneration efficiency of NH₄HSO₄ and NH₃ is considered, 0.12 t of NH₄HSO₄ and 0.025 t of NH₃ is consumed to sequester 1 t CO₂. All the chemicals used in this process can be obtained from (NH₄)₂SO₄. The current price for (NH₄)₂SO₄ is 90 US$/t [40]. So, the cost for the constituent chemicals of this process is 18 US$/t CO₂. However, in Teir's work, the cost for constituent chemicals is 1300 US$/t CO₂ when using HCl and 1600 US$/t CO₂ when using HNO_{3[}26].

### CONCLUSIONS

In conclusion, pure hydromagnesite can be produced from serpentine with regenerated ammonium salts with a net conversion of 86.3%. Amorphous silica can be obtained from the dissolution step. By-products with maximum 27.5 wt. % Fe content were obtained from the pH regulation and removal of impurities step. The additives used, NH₄HSO₄ and NH₃, can be regenerated by thermal decomposition of (NH₄)₂SO₄ preferably at 330° C. The addition of ammonia water before carbonation could significantly improve the carbonation efficiency. It must be pointed out that NH₄HCO₃ should preferably be added into solution after 60° C. to prevent the production of magnesium ammonium carbonate. The mass ratio of Mg:NH₄HCO₃:NH₃ is a key factor to control the carbonation efficiency, and it was found that when the mass ratio of Mg:NH₄HCO₃:NH₃ was 1:4:2, the carbonation efficiency achieved 95.9%. From the TGA studies, the regeneration efficiency of NH₄HSO₄ in this process 15s was found to be 95%. According to the mass balance, about 2.63 t of serpentine, 0.12 t of NH₄HSO₄, 6.82 t of NH₄HCO₃ and 0.025 t of NH₃ is required to sequester 1 t CO₂, and 2.95 t of hydromagnesite is produced.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

### REFERENCES

[1] Teir, S., Revitzer, H., Eloneva, S., Fogelholm, C.-J., Zevenhoven, R. Dissolution of natural serpentinite in mineral and organic acids. Int. J. of Min. Proc. 2007; 83: 36-46.
[2] Lackner, K. S., Wendt, C. H., Butt, D. P., Joyce, E. L., Sharp, D. H. Carbon dioxide disposal in carbonate minerals. Energy 1995; 20:1153-1170
[3] Goff, F.; Lackner, K. S. Carbon dioxide sequestering using ultramafic rocks. Environmental Geosciences 1998; 5:89-101.
[4]O'Connor W. K., Dahlin D. C., Rush G. E., Dahlin C. L., Collins W. K. Carbon dioxide sequestration by direct mineral carbonation: process mineralofy of feed and products. Miner Metall Process 2002; 19(2):95-101
[5] Park, A. A., Fan, L. CO₂ mineral sequestration: Physically activated dissolution of serpentine and pH swing process. Chem. Eng. Sci. 2004; 59: 5241-5247.
[6] Teir, S., R. Kuusik, et al. Production of magnesium carbonates from serpentinite for long-term storage of CO₂, International Journal of Mineral Processing 2007; 85(1-3): 1-15.
[7] Weber, M. Mineral flame retardants—overview & future trends. Industrial Minerals 2000; 389: 19-27.
[8] Yang, H., Z. Xu. Progress in carbon dioxide separation and capture: A review. Environmental Sciences 2008; 20(1): 14-27
[9] IPCC, IPCC special report on carbon dioxide capture and storage. Prepared by Working Group III of the Intergovemmental Panel on Climate Change (Metz, B., O. Davidson, H. C. de Coninck, M. Loos, and L. A. Meyer (eds.)), Cambridge University Press, Cambridge, United Kingdom and New York, N.Y., USA, 2005
[10] Maroto-Valer, M. M., D. J. Fauth, M. E. Kuchta, Y. Zhang, J. M. Andresen. Activation of magnesium rich minerals as carbonation feedstock materials for CO₂ sequestration. Fuel Processing Technology 2005; 86(14-15): 1627-1645.
[11] Levenspiel, O. Chemical reaction engineering. Second Ed., John Wiley and Sons, New York, USA; 1972
[12] Alexander, G., Maroto-Valer, M. M., Gafarova-Aksoy, P. Evaluation of reaction Variables in the dissolution of serpentine for mineral carbonation, Fuel. 2007; 86: 273-281
[13] Fouda, M. F. R., Amin, R. E.-S., Abd-Elzaher, M. M., Extraction of magnesia from Egyptian serpentine ore via reaction with different acids. II. Reaction with nitric and acetic acids. Bull. Chem. Soc. Jpn. 1996; 69 (7): 1913-1916.
[14] Luce, R. W., Bartlett, R. W., Parks, G. A. Dissolution kinetics of magnesium silicates. Geochim. Cosmochim. Acta 1972; 36: 35-50.
[15] Apostolidis, C. I., Distin, P. A. The kinetics of the sulphuric acid leaching of nickel and magnesium from reduction roasted serpentine. Hydrometallurgy 1978; 3: 181-196.
[16] Van Essendelft, D. T, Schobert, H. H. Kinetics of the Acid Digestion of Serpentine with Concurrent Grinding. 1. Initial Investigations, Ind. Eng. Chem. Res. 2009; 48: 2556-2565
[17] McKelvy, M. J., Chizmesya, A. V. G., Diefenbacher, J., Béarat, H., Wolf, G. Exploration of the role of heat activation in enhancing serpentine carbon sequestration reactions, Environm. Sci. and Technol. 2004; 38: 6897-6903.
[18] Working Group III of the Intergovernmental Panel on Climate Change (Metz, B. and H. C. d. C. O. Davidson, M. Loos, and L. A. Meyer (eds.), IPCC special report on carbon dioxide capture and storage. 2005, Cambridge, University Press: Cambridge, United Kingdom and New York, N.Y., USA.
[19] Class, H., A. Ebigbo., A benchmark study on problems related to CO₂ storage in geologic formations. Computational Geosciences, 2009. 13(4): p. 409-434.
[20] Teir, S., Revitzer, H., Dissolution of natural serpentinite in mineral and organic acids. International Journal of Mineral Processing, 2007. 83(1-2): p. 36-46.
[21] Goff F, L. K., carbon dioxide sequestering using ultramafic rocks. Environmental Geoscience, 1998. 5: p. 89-101.
[22] Lackner, K. S. Z., H. J., From low to no emissions. Modern Power Systems, 2000. 20(3): p. 31-32.
[23] Maroto-Valer, M. M., Fauth D. J., Zhang Y. and Andresen J. M., Activation of magnesium rich minerals as carbonation feedstock materials for CO₂ sequestration. Fuel Processing Technology, 2005. 86(14-15): p. 1627-1645.
[24] Park, A.-H. A. and L.-S. Fan, CO₂ mineral sequestration: physically activated dissolution of serpentine and pH swing process. Chemical Engineering Science, 2004. 59(22-23): p. 5241-5247.
[25] Gerdemann, S. J., O'Connor W. K., Ex situ aqueous mineral carbonation. Environmental Science & Technology, 2007. 41(7): p. 2587-2593.
[26] Teir, S., Kuusik R., Production of magnesium carbonates from serpentinite for long-term storage of CO₂. International Journal of Mineral Processing, 2007. 85(1-3): p. 1-15.
[27] Krevor, S. C. and K. S. Lackner, Enhancing process kinetics for mineral carbon sequestration. Energy Procedia, 2009. 1(1): p. 4867-4871.
[28] Pundsack, F. L., Recovery of silica, iron oxide and magnesium carbonate from the treatment of serpentine with ammonium bisulfate U.S. Pat. No. 3,338,667, 1967
[29] Fagerlund, J., Teir S., Carbonation of magnesium silicate mineral using a pressurised gas/solid process. Energy Procedia, 2009. 1(1): p. 4907-4914.
[30] Experience Nduagu, Ron Zevenhoven, Production of magnesium hydroxide from magnesium silicate for the purpose of CO₂ mineralisation and Increasing ocean alkalinity: effect of reaction parameters, in ACEME 10. 2010: Turku, Finland.
[31] Ron Zevenhoven, T. B., Johan Fagerlund, Ines Romao, James Highfield, Bu Jie, Assessment & improvement of a stepwise magnesium silicate carbonation route via MgSO₄ & Mg(OH)₂, in ACEME 10. 2010: Turku, Finland.
[32] Wang Xiaolong, Mercedes Maroto-Valer, Dissolution of serpentine using recyclable ammonium salts for CO₂ mineral carbonation. Fuel, 2010.
[33] Huijgen, W. J. J., G.-J. Witkamp, and R. N. J. Comans, Mechanisms of aqueous wollastonite carbonation as a possible CO₂ sequestration process. Chemical Engineering Science, 2006. 61(13): p. 4242-4251.
[34] Everingham, J. R., Hoenke, Karl A., Lawn moss control with ferric ammonium sulfate-ammonium sulfate double salts in U.S. Pat. No. 3,964,893. 1976: U.S.
[35] Zhang Yun, L. Z.-z., Li Xin, Dong Jiang-xun, Wang Yang, Scott M. Smouse and James M. Ekmann, Preliminary Study to Capture CO₂ in Flue Gas by Spraying Aqueous Ammonia to Produce NH₄HCO₃. 2003, National Power Plant Combustion Engineering Technology Research Center, Shenyang, P. R. China; U.S. Department of Energy, National Energy Technology Laboratory.
[36] Cesca, T., Process for the production of magnesium oxide, in U.S. Pat. No. 1971.
[37] Brennan Earl D., Pa. M., Method for the thermal conversion of ammonium sulfate to ammonium bisulfate in U.S. Pat. No. 1975.
[38] Bretherick Ormond, Calif B., Method for converting ammonium sulfate ammonium bisulfate U.S. Pat. No., Editor. 1975.
[39] Montgomery, J. C., Apparatus for decomposing solid ammonium sulfate, in U.S. Pat. No. 1962.
[40] ICIS. Chemical price report. 2010; Available from: http://www.icis.com/staticpages/generalpriceslanding.htm?cp=KNC-CHPR-Generalprices 2010&sfid=70120000000Hu8n&mode=icispricing.

1. A method for capturing carbon dioxide comprising the steps of:
extracting mineral ions from a mineral source material to a mineral solution by reaction with a first ammonium salt;
capturing carbon dioxide from a waste stream by reacting with ammonia to form an intermediate product of ammonium bicarbonate;
reacting the mineral solution with the intermediate product to precipitate a carbonate of the mineral and to produce a second ammonium salt;
and recovering the first ammonium salt from the second ammonium salt.

2. (canceled)

3. The method according to claim 1 wherein the mineral ions are magnesium ions or calcium ions.

4. The method according to claim 1 wherein the mineral source material is a magnesium silicate or a calcium silicate.

5. The method according to claim 1 wherein the first ammonium salt is ammonium bisulphate.

6. The method according to claim 1 wherein the mineral solution is regulated to neutral pH with ammonia before it is reacted with the CO₂ source.

7.-9. (canceled)

10. The method according to claim 1 wherein the recovering the first ammonium salt from the second ammonium salt comprises production of ammonia.

11. The method according to claim 10 wherein the ammonia is used for capturing CO₂.

12. The method according to claim 1 wherein the first ammonium salt is recovered by a process comprising heating to a temperature of from 250° C. to 350° C.

13. The method according to claim 1 wherein the recovered first ammonium salt is used for further extraction of mineral ions from the mineral source material.

14.-22. (canceled)

23. The method according to claim 1 wherein the mineral ions are magnesium ions, and wherein they are reacted in the presence of ammonia in a mass ratio of Mg:NH₄HCO₃:NH₃ of from 1:3:1 to 1:4:2.

24. The method according to claim 1 wherein the intermediate product is mixed with the mineral solution at a temperature above 50.

25. A process for producing power comprising the steps of:
producing CO₂ by burning a fuel;
and capturing the CO₂ using a method according to claim 1.

26. An apparatus for capturing carbon dioxide comprising means adapted for connection to a flue and means for performing the method according to claim 1.
